(19) United States
(12) Patent Application Publication
(10) Pub. No.: US 2024/0357393 A1
(43) Pub. Date: Oct. 24, 2024

(54) CSI-RS RESOURCE CONFIGURATION FOR CSI MEASUREMENT

(71) Applicant: QUALCOMM Incorporated, San Diego, CA (US)

(72) Inventors: Hung Dinh LY, San Diego, CA (US); Muhammad Sayed Khairy ABDELGHAFFAR, San Jose, CA (US); Yu ZHANG, San Diego, CA (US)

(21) Appl. No.: 18/294,511

(22) PCT Filed: Sep. 30, 2021
(86) PCT No.: PCT/CN2021/122182

§ 371 Date: Feb. 1, 2024

(51) Int. Cl. H04W 24/10; H04L 5/00

(52) U.S. Cl. CPC H04W 24/10; H04L 5/0053; H04L 5/0096

(57) ABSTRACT

Aspects are provided which allow a base station to provide CSI report configurations and a UE to provide CSI reports in response to such configurations which account for a power savings mode of the base station. While in the power savings mode, the base station may deactivate one or more of its antenna panels or sub-panels to reduce energy expenditure, for example, while performing dynamic antenna port adaptation. To account for this antenna port deactivation, the base station may send a CSI report configuration to a UE including one or more measurement resource sets associated with the power savings mode. The UE may obtain the CSI report configuration and send a CSI report to the base station in response to a CSI measurement in the one or more measurement resource sets.

### BACKGROUND

### Technical Field

The present disclosure generally relates to communication systems, and more particularly, to a wireless communication system between a user equipment (UE) and a base station.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE obtains a channel state information (CSI) report configuration from a base station, where the CSI report configuration includes one or more measurement resource sets supporting deactivation of base station antenna ports. The UE sends a CSI report to the base station in response to a CSI measurement in the one or more measurement resource sets.

In an aspect of the disclosure, a method, a computer-readable medium, and an apparatus are provided. The apparatus may be a base station. The base station sends a CSI report configuration to a UE, where the CSI report configuration includes one or more measurement resource sets supporting deactivation of base station antenna ports. The base station obtains a CSI report from the UE in response to a CSI measurement in the one or more measurement resource sets.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example chart showing differences in per-cell power consumption between different radio access technology (RAT) deployments in various loading scenarios.

FIG. 5 is a diagram illustrating an example of a base station employing dynamic antenna port adaptation while in a power savings mode.

FIG. 6 is a diagram illustrating an example of a CSI report configuration which a base station may configure and provide to a UE.

FIG. 7 is a diagram illustrating an example of a CSI report configuration according to an aspect of the present disclosure.

FIG. 8 is a diagram illustrating an example of a CSI report configuration according to another aspect of the present disclosure.

FIG. 9 is a call flow diagram between a UE and a base station.

FIG. 10 is a flowchart of a method of wireless communication at a UE.

FIG. 11 is a flowchart of a method of wireless communication at a base station.

FIG. 12 is a diagram illustrating an example of a hardware implementation for an example apparatus.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In recent years following the advent of 5G/NR technology, a growing concern has arisen regarding the amount of power consumed by cellular networks. For example, 5G massive MIMO (mMIMO) technology, which enables an increase in data throughput compared to LTE MIMO technology (e.g., based on a larger number of antennas for transmission (Tx) or reception (Rx) and other factors), results in significantly higher power consumption than its earlier counterpart. Moreover, growing environmental factors such as carbon emissions also contribute to an increase in power consumed. As a result, the power consumption of cellular networks may significantly affect network operator expenditures (OPEX).

To help reduce the power consumption and associated OPEX, efforts by the network have been taken to achieve network energy savings. For example, networks have employed dynamic base station antenna adaptation, in which base stations (e.g., single transmission/reception points (sTRPs)) supporting mMIMO technology with multiple co-located antenna panels (or sub-panels) may power off one or more of these panels or sub-panels in order to reduce energy expenditure. For instance, when the base station is operating in a power saving mode in which the base station applies dynamic antenna port adaptation, the base station may deactivate a number of its panels or sub-panels in order to fallback to a half duplex mode from a full duplex mode, or to reduce power consumption during times of low traffic or cell activity (e.g., low loading scenarios). However, such efforts typically lack UE interaction or involvement; for example, UEs may not be configured to provide CSI reports indicating to the base station which panel(s) or sub-panel(s) may be deactivated. Therefore, it would be helpful to optimize network power consumption and energy efficiency by involving the UE in such efforts (e.g., in dynamic base station antenna adaptation).

Generally, a base station provides a CSI report configuration to the UE configuring one resource set including non-zero power (NZP) channel measurement resources (CMR). The base station may select the NZP CMR resource set based at least on the number of its currently active antenna ports, and the base station may transmit CSI reference signals (CSI-RS) in each resource of the resource set for the UE to perform CSI measurements. However, if the base station performs dynamic antenna port adaptation in which the base station deactivates one or more of its antenna panels (or sub-panels) to reduce energy expenditure in a power savings mode, the number of active antennas available for transmitting CSI-RS may similarly reduce and the previously selected NZP CMR resource set in the CSI report configuration may no longer apply. Although the base station may provide a new CSI report configuration with a new NZP CMR resource set applicable for the reduced number of antennas, such approach may be inefficient if the base station has to provide a new CSI report configuration every time it deactivates or re-activates one or more of its antenna panels or sub-panels. It would therefore be helpful to provide options for configuring NZP CSI-RS resources for channel measurement (or, similarly, other resources for interference measurement) in view of dynamic antenna port adaptation.

To these ends, aspects of the present disclosure allow the base station to provide CSI report configurations which account for a power savings mode of the base station. While the base station is operating in the power savings mode, the base station may deactivate one or more of its antenna panels or sub-panels to reduce energy expenditure. To account for this antenna port deactivation, the base station may configure one or more resource sets in the CSI report configuration including resources associated with the power savings mode (referred to here as “power saving resources”) and resources not associated with the power savings mode (referred to here as “non-power saving resources”). Here, power saving resources refer to resources in which the base station may transmit CSI-RS from active (not deactivated) antenna ports while operating in the power savings mode, and non-power saving resources refer to resources in which the base station may transmit CSI-RS from its antenna ports while not operating in the power savings mode. The resources may be channel measurement resources of one or more channel measurement resource sets, or interference measurement resources of one or more interference measurement resource sets. The base station may dynamically indicate whether the base station is transmitting CSI-RS in power saving resources or non-power saving resources, and the UE may measure CSI in the indicated resources accordingly for CSI reporting. Such approach allows the base station to efficiently configure CSI reporting for dynamic antenna port adaptation through a single CSI report configuration, rather than inefficiently through multiple CSI report configurations to support dynamic antenna port adaptation (or different dynamic antenna port adaptations). Alternatively, the UE may measure CSI in power saving resources and non-power saving resources for CSI reporting, and the base station may determine from the CSI report which antenna ports (e.g., panels or sub-panels) to deactivate. Such approach allows the UE to become involved in the dynamic antenna port adaptation process (e.g., which antenna ports the base station may deactivate) and thus promotes UE involvement in network energy saving efforts. Moreover, after the base station determines which antenna ports to deactivate from the CSI report, the base station may provide dynamic indications of resources as previously described. In this way, UE involvement in network energy savings with efficient CSI report configurations may be achieved.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

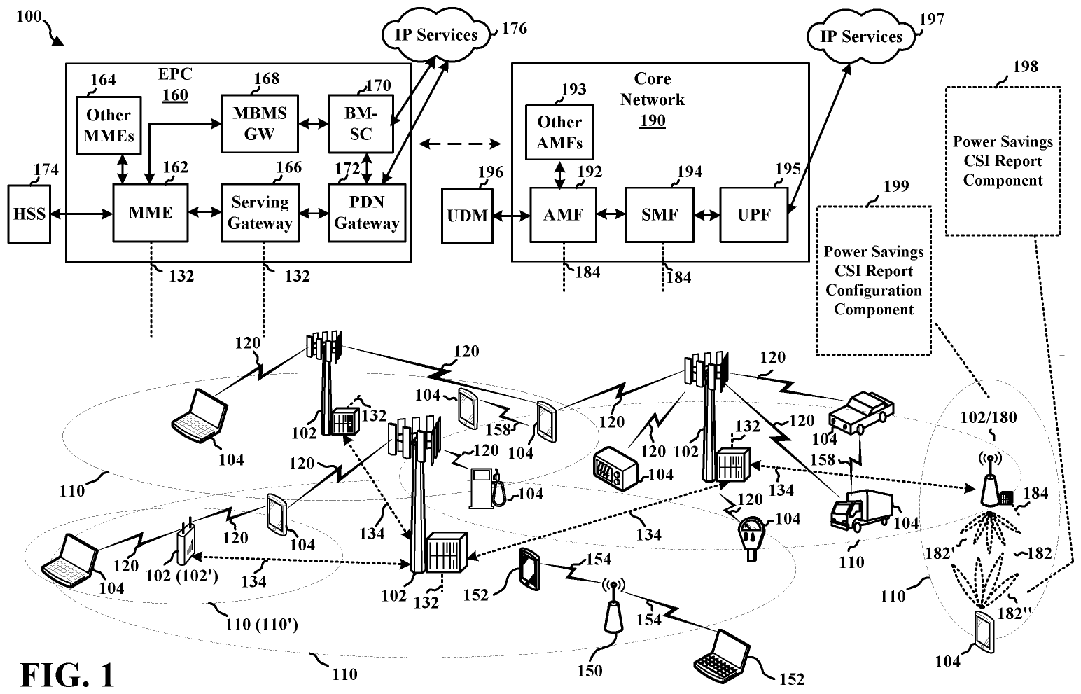

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a power savings CSI report component 198 that is configured to obtain a CSI report configuration from a base station, where the CSI report configuration includes one or more measurement resource sets supporting deactivation of base station antenna ports; and send a CSI report to the base station in response to a CSI measurement in the one or more measurement resource sets.

Referring again to FIG. 1, in certain aspects, the base station 180 may include a power savings CSI report configuration component 199 that is configured to send a CSI report configuration to a UE, where the CSI report configuration includes one or more measurement resource sets supporting deactivation of base station antenna ports; and obtain a CSI report from the UE in response to a CSI measurement in the one or more measurement resource sets.

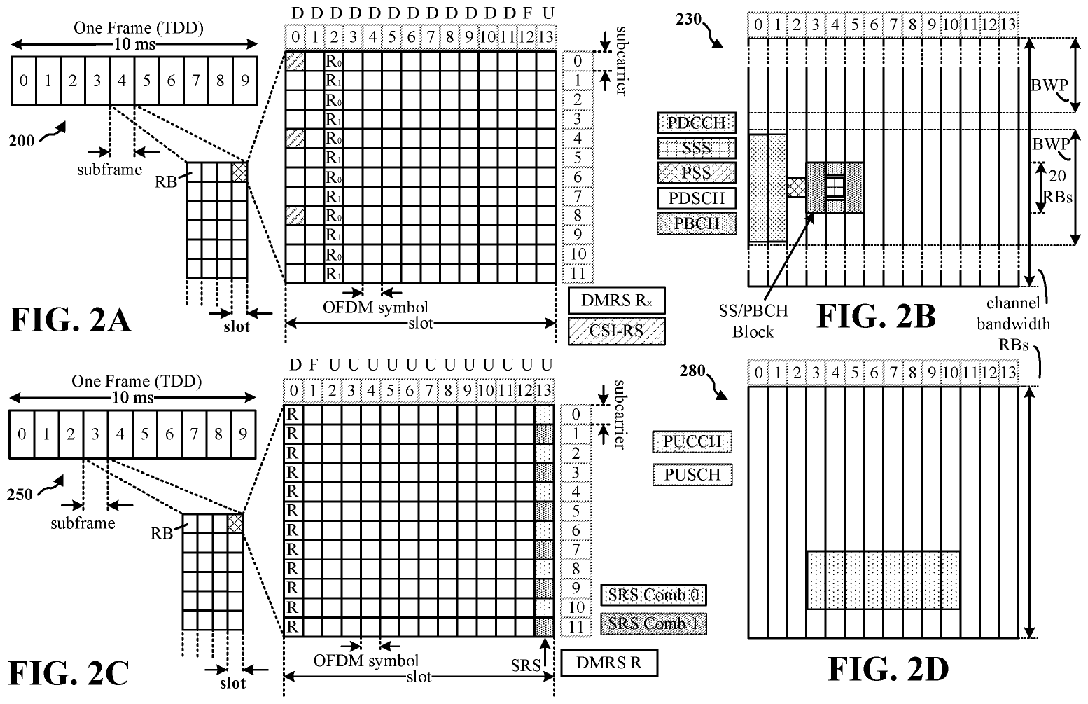

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

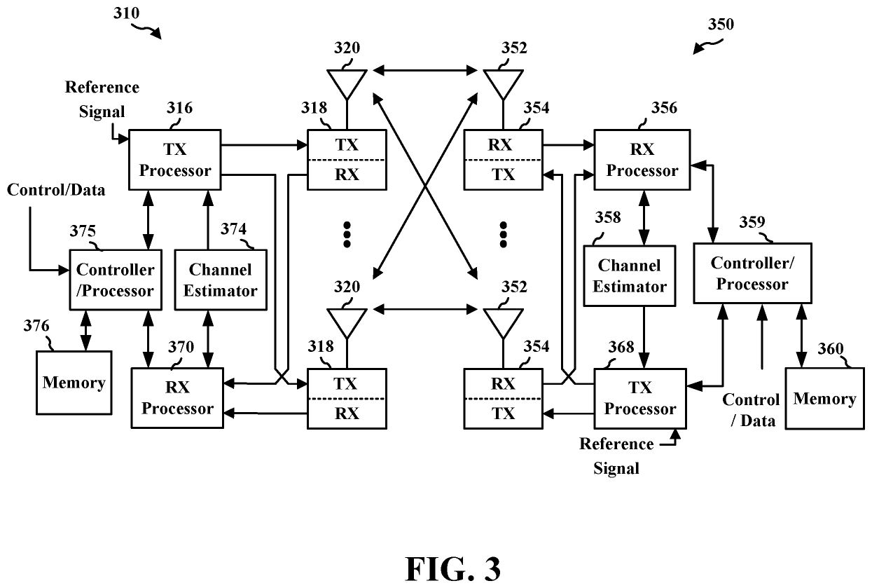

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with power savings CSI report component 198 of FIG. 1.

At least one of the TX processor 316, the RX processor 370, and the controller/processor 375 may be configured to perform aspects in connection with power savings CSI report configuration component 199 of FIG. 1.

In recent years following the advent of 5G/NR technology, a growing concern has arisen regarding the amount of power consumed by cellular networks. For example, 5G mMIMO technology, which enables an increase in data throughput compared to LTE MIMO technology (e.g., based on a larger number of antennas for Tx or Rx and other factors), results in significantly higher power consumption than its earlier counterpart. Moreover, growing environmental factors such as carbon emissions also contribute to an increase in power consumed. As a result, the power consumption of cellular networks may significantly affect network OPEX.

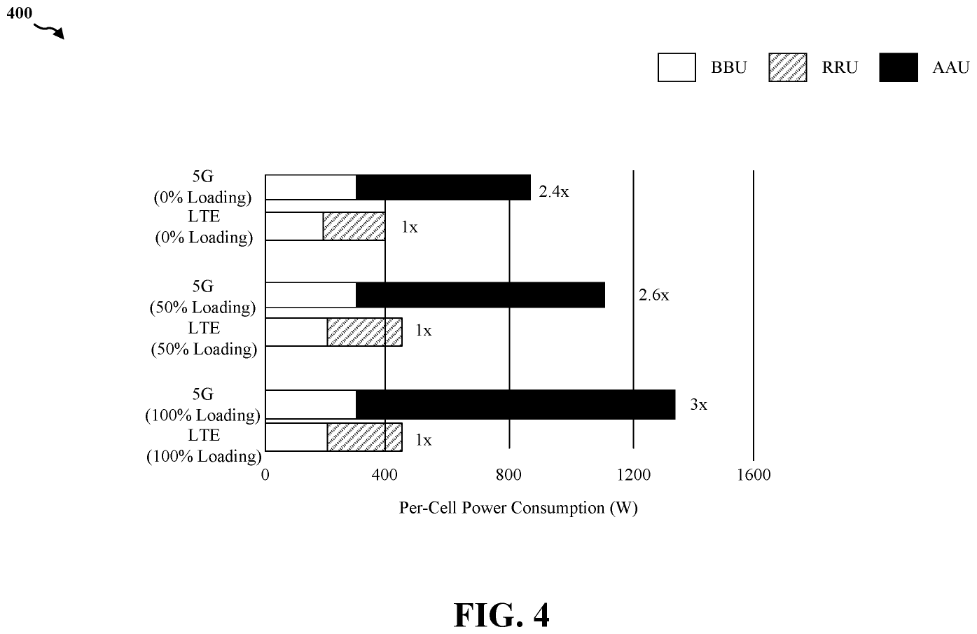

FIG. 4 illustrates an example chart 400 showing differences in per-cell power consumption between 4G/LTE and 5G/NR deployments in various loading scenarios, namely 100% loading (e.g., total system resources are currently being used for MIMO/mMIMO data transmissions), 50% loading (e.g., half of total system resources are currently being used for MIMO/mMIMO data transmissions), and 0% loading (e.g., no system resources are currently being used for MIMO/mMIMO data transmissions). In 4G/LTE deployments, network power consumption may include the power consumed by baseband units (BBUs) and remote radio units (RRUs) in performing MIMO, while in 5G/NR deployments, network power consumption may include the power consumed by BBUs and active (or adaptive) antenna units (AAUs) in performing mMIMO. Network power consumption may also include the power consumed for air conditioning to cool down the base stations (e.g., the BBUs/RRUs/AAUs). As loading increases, the total network power consumption of base stations may also increase.

Thus, as illustrated in the example chart 400, network power consumption for 5G/NR deployments may be significantly greater than network power consumption for 4G/LTE deployments. As shown in FIG. 4, this difference in power may be most apparent from the power consumption of AAUs, which can amount to 90% of total network power consumption in 5G/NR. This power, combined with that of the BBUs in the illustrated example, may amount to approximately 2.4-3 times the amount of power consumed in 4G/LTE deployments at maximum loading. Such significant increase in power may occur in response to, for example, the use of higher frequency bands, wider bandwidths, and more Tx/Rx antennas in 5G/NR compared to 4G/LTE, among other factors. As a result, maximizing mMIMO data throughput may result in significant OPEX for a network operator. For instance, electricity costs associated with base stations may typically amount to nearly 20% of overall network operating costs, and in some cases, such electricity costs may even amount to more than half of total profits.

To help reduce the power consumption and associated OPEX, efforts by the network have been taken to achieve network energy savings. For example, networks have employed dynamic base station antenna adaptation, in which base stations (e.g., single TRPs) supporting mMIMO technology with multiple co-located antenna panels (or sub-panels) may power off one or more of these panels or sub-panels in order to reduce energy expenditure. For instance, when the base station is operating in a power saving mode in which the base station applies dynamic antenna port adaptation, the base station may deactivate a number of its panels or sub-panels in order to fallback to a half duplex mode from a full duplex mode, or to reduce power consumption during times of low traffic or cell activity (e.g., low loading scenarios). However, such efforts typically lack UE interaction or involvement; for example, UEs may not be configured to provide CSI reports indicating to the base station which panel(s) or sub-panel(s) may be deactivated. Therefore, it would be helpful to optimize network power consumption and energy efficiency by involving the UE in such efforts (e.g., in dynamic base station antenna adaptation).

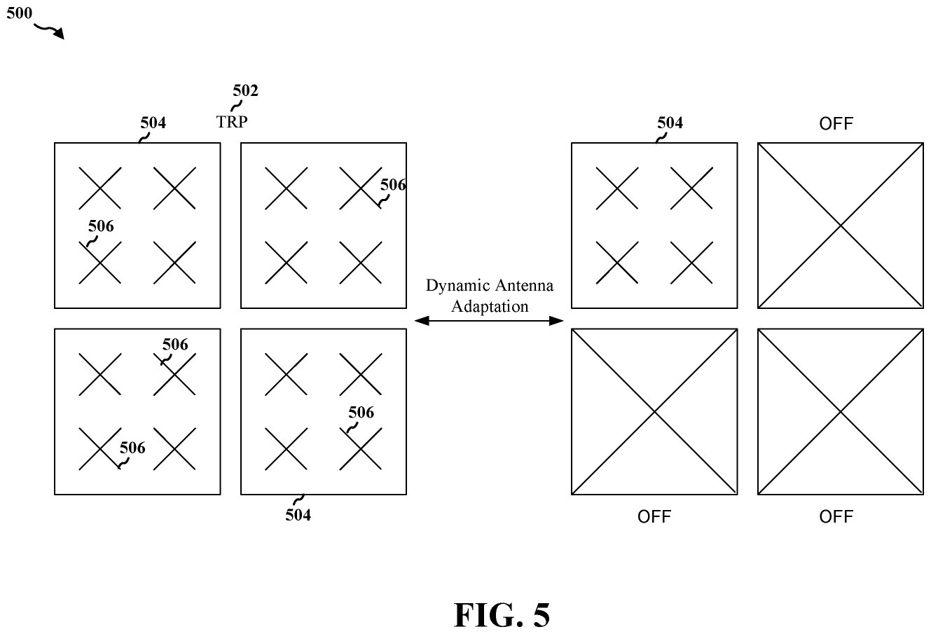

FIG. 5 illustrates an example 500 of a base station (e.g., TRP 502) employing dynamic antenna port adaptation while in a power savings mode. The base station may include antenna panels 504, where each of the antenna panels includes one or more antennas 506 (e.g., antennas 320 in FIG. 3). For instance, in the example of FIG. 5, TRP 502 may include 4 antenna panels, with each panel including 8 antennas (e.g., 32 antennas in total), although the number of antenna panels and antennas may be different in other examples. Alternatively, in the example of FIG. 5, TRP 502 may include 1 antenna panel with 4 antenna sub-panels, with each sub-panel including 8 antennas (e.g., 32 antennas in total), although the number of antenna sub-panels and antennas may similarly be different in other examples. At certain times when the base station is not in a power savings mode (e.g., high loading scenarios), the base station may transmit and receive data using all of its configured antennas and panels/sub-panels. However, at other times when the base station is in a power savings mode (e.g., low loading scenarios), the base station may determine to perform dynamic antenna port adaptation in order to reduce energy expenditure. For instance, in the example of FIG. 5, the base station may deactivate three of its 4 antenna panels (or sub-panels) such that only 8 antennas remain active in order to save a certain amount of power consumption, although the number of antenna panels (or sub-panels) that may be deactivated may be different in other examples. For example, the base station may deactivate less panels or sub-panels in higher loading scenarios.

The base station may also generate and transmit one or more CSI-RS (e.g., using antennas 506 in active panels of FIG. 5) in order to allow the UE to measure channel quality and report channel quality measurement results. For example, the base station may configure one or more CSI-RS in a set of CSI-RS resources based on various RRC parameters (e.g. periodicity, frequency density, symbol and subcarrier locations, number of antenna ports, etc.), and map the CSI-RS to the resources based on the configuration. The base station may also configure the UE to provide CSI reports based on channel measurements using the CSI-RS. For example, the base station may provide a CSI report configuration to the UE which includes various RRC parameters (e.g. what CSI should be measured and reported, the serving cell and bandwidth part where the CSI-RS may be found, etc.). CSI may include various reporting parameters including CQI, PMI, RI, and LI, as well as other CSI (e.g. L1-RSRP, etc.). The base station may schedule CSI reports to occur in response to CSI-RS periodically, semi-persistently, or aperiodically. When CSI-RS and CSI reports are scheduled semi-persistently or aperiodically, the base station may trigger or activate CSI reporting on PUCCH via a MAC CE, or on PUSCH via a DCI.

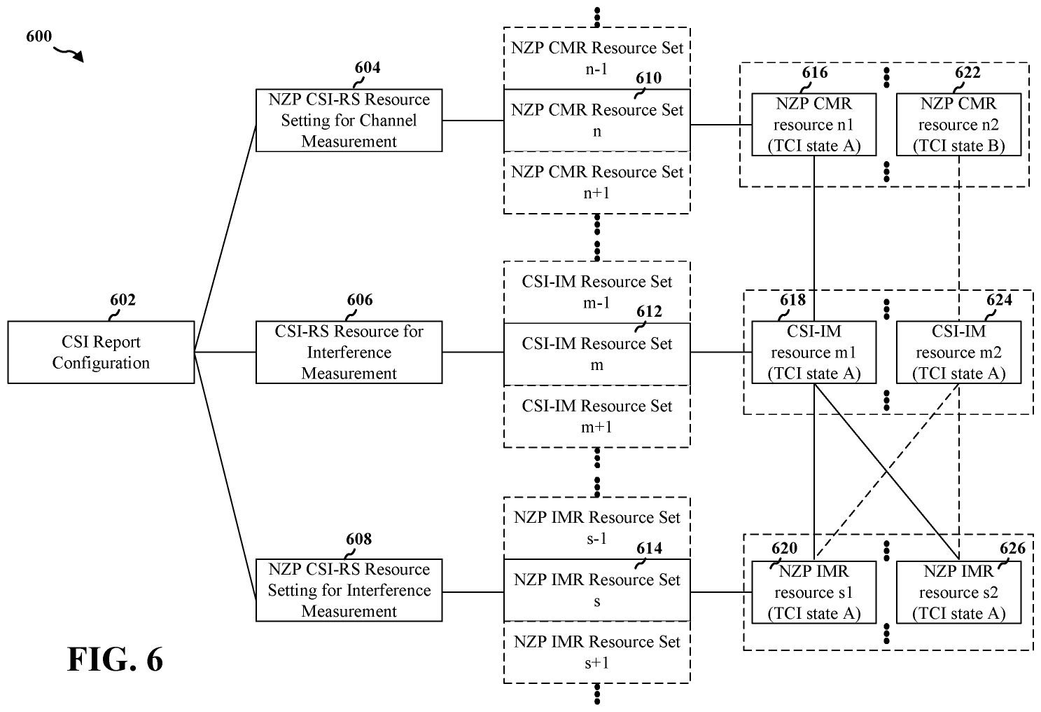

FIG. 6 illustrates an example 600 of a CSI report configuration 602 which a base station (e.g., a single TRP) may configure and provide to a UE. The CSI report configuration may be associated with (e.g. include an index or other link to) a CSI-RS resource setting for channel measurement and optionally one or more CSI-RS resource settings for interference measurement. For instance, in the example of FIG. 6, the CSI report configuration 602 may be associated with a NZP CSI-RS resource setting for channel measurement (e.g., a resource setting for channel measurement resources, or CMR resource setting 604). Moreover, CSI report configuration 602 may optionally be additionally associated with a zero-power (ZP) CSI-RS resource setting for interference measurement (e.g., a resource setting for CSI-RS interference measurement (CSI-IM) resources, or CSI-IM resource setting 606) and/or a NZP CSI-RS resource setting for interference measurement (e.g., a resource setting for NZP interference measurement resources (NZP IMR), or NZP IMR resource setting 608). Thus, CSI report configuration 602 may be associated with only a CMR resource setting 604, the CMR resource setting plus either a CSI-IM resource setting 606 or a NZP IMR resource setting 608, or the CMR resource setting plus both the CSI-IM resource setting and NZP IMR resource setting.

Moreover, each resource setting may be associated with (e.g. include an index or other link to) a single CSI-RS resource set selected by the base station from one of multiple resource sets. For instance, in the example of FIG. 6, the base station may associate CMR resource setting 604 with NZP CMR resource set n 610 for channel measurements (which resource set the base station may select from one of multiple CMR resource sets including CMR resource set n−1, n+1, etc.). Additionally, the base station may associate CSI-IM resource setting 606 with CSI-IM resource set m 612 for interference measurements (which the base station may select from one of multiple CSI-IM resource sets including CSI-IM resource set m−1, m+1, etc.), and/or the base station may associate NZP IMR resource setting 608 with NZP IMR resource set s 614 for interference measurements (which the base station may select from one of multiple NZP IMR resource sets including NZP IMR resource set s−1, s+1, etc.).

Furthermore, each CSI-RS resource set in a CSI report configuration may include one or more CSI-RS resources in which the UE may measure CSI for subsequent CSI reporting. For example, referring to FIG. 6, NZP CMR resource set n 610 may include N CMR resources for channel measurement, and after measuring CSI in all N CMR resources, the UE may select one of the N CMR resources which the UE determines to have the best performance (e.g., highest signal-to-noise and interference (SINR) ratio) for its CSI feedback. For instance, in the example of FIG. 6, the UE may select NZP CMR resource n1 616 in response to CSI measurements in all N resources of NZP CMR resource set n 610. Similarly, CSI-IM resource set m may include M CSI-IM resources for interference measurement and NZP IMR resource set s may include S NZP IMR resources for interference measurement, and after measuring CSI in all M CSI-IM resources and/or S NZP IMR resources, the UE may similarly select one of the M CSI-IM resources and/or one of the S NZP IMR resources which the UE determines to have the best performance for its CSI feedback. For instance, in the example of FIG. 6, the UE may select CSI-IM resource m1 618 in response to CSI measurements in all M resources of CSI-IM resource set m 612, and/or the UE may select NZP IMR resource s1 620 in response to CSI measurements in all S resources of NZP IMR resource set s 614.

Additionally, each of the N CMR resources, M CSI-IM resources, and S NZP IMR resources may include resources associated with different transmission configuration indicator (TCI) states (e.g., for different TRPs), and the UE may select the resources associated with a given TCI state for each TRP. For instance, in the example of FIG. 6, the UE may select NZP CMR resource n1 616 (corresponding to one TCI state A for one TRP) and NZP CMR resource n2 622 (corresponding to another TCI state B for another TRP) in response to CSI measurements in all N resources of NZP CMR resource set n 610. Similarly, the UE may select CSI-IM resource m1 620 (corresponding to TCI state A for one TRP) and CSI-IM resource m2 624 (corresponding to TCI state b for another TRP) in response to CSI measurements in all M resources of CSI-IM resource set m 612, and the UE may select NZP IMR resource s1 624 (corresponding to TCI state A for one TRP) and NZP IMR resource s2 626 (corresponding to TCI state B for another TRP) in response to CSI measurements in all S resources of NZP IMR resource set s 614. Moreover, as illustrated in FIG. 6, the selected NZP CMR resource may be associated with the selected CSI-IM resource of the same TCI state, and the selected CSI-IM resource may be associated with the selected NZP IMR resources of different TCI states. For example, NZP CMR resource n1 616 may be associated with CSI-IM resource m1 618, and CSI-IM resource m1 618 may be associated with cither NZP IMR resource s1 620 or NZP IMR resource s2 626. Similarly, NZP CMR resource n2 622 may be associated with CSI-IM resource m2 624, and CSI-IM resource m2 624 may be associated with either NZP IMR resource s1 620 or NZP IMR resource s2 626.

When the UE provides a CSI report to the base station including measured CSI from a selected resource (e.g., a selected resource in a NZP CMR resource set, a CSI-IM resource set, and/or a NZP IMR resource set), the UE may include a CSI-RS resource indicator (CRI) associated with the selected resource(s) in the CSI report. The CRI may indicate to the base station which selected resource(s) corresponds to the reported CSI. For instance, after measuring CSI in all N resources of configured NZP CMR resource set n, the UE may determine that NZP CMR resource n1 616 is associated with the highest SINR of the measured NZP CMR resources, and the UE may report the CRI associated with NZP CMR resource n1 616 in the CSI report. Similarly, after measuring CSI in all M and/or S resources of configured CSI-IM resource set m and/or NZP IMR resource set s, the UE may determine that CSI-IM resource m1 618 is associated with the highest SINR of the measured CSI-IM resources and that NZP IMR resource s1 620 is associated with the highest SINR of the measured NZP IMR resources, and the UE may report the CRI(s) associated with the CSI-IM resource me 618 and/or NZP IMR resource s1 620 in the CSI report.

One example of CSI which the UE may measure and report in a selected NZP CMR resource (e.g., NZP CMR resource n1 or NZP CMR resource n2 in the example of FIG. 6) includes PMI. The PMI reported by the UE in the CSI report for a given resource (e.g., CRI) may be based on a PMI codebook. This PMI codebook may be dependent upon one of various PMI codebook types, such as Type I single-panel, Type I multiple panels, Type II single panel, Type II port selection, and Type II enhanced port selection. Moreover, each codebook type may be associated with a number of supported configurations of antenna elements identified by number of panels N_{g} and dimensions N₁ and N₂, where N₁ represents the number of antennas in a row of a panel and N₂ represents the number of antennas in a column of a panel, which antenna panel/element arrangement corresponds to a configured number of CSI-RS antenna ports (P_{CSI-RS}) for a given resource. Generally, the number of CSI-RS antenna ports P_{CSI-RS} may be represented by the formula P_{CSI-RS}=2N_{g}N₁N₂, with different configurable values of P_{CSI-RS}, N_{g}, N₁, N₂ being identified from a table of supported antenna port configurations for a given codebook type. Thus, the PMI reported by the UE may be based on an antenna configuration of the base station for CSI-RS as well as a configured PMI codebook type. Examples of antenna configurations for Type 1 single-panel and Type 1 multiple panel codebooks are shown below in Tables 1 and 2, respectively:

TABLE 1

| Number of | |
|---|---|
| CSI-RS antenna ports, P_{CSI-RS} | (N₁, N₂) |
| 4 | (2, 1) |
| 8 | (2, 2) |
| | (4, 1) |
| 12 | (3, 2) |
| | (6, 1) |
| 16 | (4, 2) |
| | (8, 1) |
| 24 | (4, 3) |
| | (6, 2) |
| | (12, 1) |
| 32 | (4, 4) |
| | (8, 2) |
| | (16, 1) |

TABLE 2

| Number of | |
|---|---|
| CSI-RS antenna ports, P_{CSI-RS} | (N_{g}, N₁, N₂) |
| 8 | (2, 2, 1) |
| 16 | (2, 4, 1) |
| | (4, 2, 1) |
| | (2, 2, 2) |
| 32 | (2, 8, 1) |
| | (4, 4, 1) |
| | (2, 4, 2) |
| | (4, 2, 2) |

Additionally, all resources in a resource set may be associated with a same number of transmission antenna ports. For example, each of the N resources in NZP CMR resource set n 610 (including NZP CMR resource n1 616 and NZP CMR resource n2 622) may be associated with 32 CSI-RS antenna ports according to Table 2 above (Type 1 multiple panel PMI codebook). Similarly, each of the N resources in NZP CMR resource set n−1 may be associated with a same number of CSI-RS antenna ports (e.g., 8, 16, or 32 according to Table 2), each of the N resources in NZP CMR resource set n+1 may be associated with a same number of CSI-RS antenna ports (e.g., 8, 16, or 32 according to Table 2), and so forth for each NZP CMR resource set.

Generally, a base station provides a CSI report configuration to the UE configuring one NZP CMR resource set (e.g., NZP CMR resource set n 610 in the example of FIG. 6) in a NZP CSI-RS resource setting for channel measurement (e.g., NZP CMR resource setting 604). The base station may select the NZP CMR resource set based at least on the number of its currently active antenna ports. For example, if NZP CMR resource set n 610 is associated with 32 CSI-RS antenna ports such as described above, and if the base station (e.g., TRP 502) intends to transmit CSI-RS using 32 of its antennas 506 in four of its antenna panels 504 such as illustrated in FIG. 5, the base station may select NZP CMR resource set n 610 when configuring its CSI report configuration 602 to match the number of antenna ports accordingly. The UE may then perform channel measurements over each of the N resources in the selected NZP CMR resource set, select the NZP CMR resource with the best performance (e.g., highest SINR), and report the CRI associated with the selected NZP CMR resource in its CSI report (along with the PMI, CQI, and other CSI).

However, if the base station performs dynamic antenna port adaptation in which the base station deactivates one or more of its antenna panels (or sub-panels) to reduce energy expenditure in a power savings mode, the number of active antennas available for transmitting CSI-RS may similarly reduce. For example, if the base station (e.g., TRP 502) deactivates three of its antenna panels 504 in response to dynamic antenna port adaption such as illustrated in FIG. 5, the base station may transmit CSI-RS using only 8 of its antennas 506 remaining in the active antenna panel. As a result, the previously selected NZP CMR resource set in the CSI report configuration may no longer apply. For example, if NZP CMR resource set n 610 was selected and associated with 32 CSI-RS antenna ports, that resource set may later become invalid if the base station reduces its available number of CSI-RS antenna ports (e.g., to 8) in response to dynamic antenna port adaptation. Although the base station may provide a new CSI report configuration with a new NZP CMR resource set applicable for 8 CSI-RS antenna ports in this example, such approach may be inefficient if the base station has to provide a new CSI report configuration every time it deactivates or re-activates one or more of its antenna panels or sub-panels. It would therefore be helpful to provide options for configuring NZP CSI-RS resources for channel measurement (and/or CSI-IM resources or NZP IMR resources for interference measurement) in view of dynamic antenna port adaptation.

Aspects of the present disclosure allow the base station to provide CSI report configurations which account for a power savings mode of the base station. While the base station is operating in the power savings mode, the base station may deactivate one or more of its antenna panels or sub-panels to reduce energy expenditure. For example, while operating in the power savings mode, the base station may deactivate a number of its antenna panels 504 or sub-panels to reduce power consumption through dynamic antenna port adaptation (e.g., during low loading scenarios), such as described above with respect to FIG. 5. To account for this antenna port deactivation, the base station may configure one or more resource sets in the CSI report configuration including resources associated with the power savings mode (referred to here as “power saving resources”) and resources not associated with the power savings mode (referred to here as “non-power saving resources”). Here, power saving resources refer to resources in which the base station may transmit CSI-RS from active (not deactivated) antenna ports while operating in the power savings mode, and non-power saving resources refer to resources in which the base station may transmit CSI-RS from its antenna ports while not operating in the power savings mode. The resources may be NZP CMR resources of one or more NZP CMR resource sets, CSI-IM resources of one or more CSI-IM resource sets, and/or NZP IMR resources of one or more NZP IMR resource sets. For example, referring to FIG. 5, if the base station is operating in the power savings mode (e.g., TRP 502 has deactivated one or more of its configured antenna panels 504 or sub-panels for CSI-RS), the base station may transmit CSI-RS from its active (not de-activated) antenna ports in power saving resources associated with 8 antenna ports for the UE to measure CSI. On the other hand, if the base station has not entered the power savings mode (e.g., the TRP 502 has not deactivated any of its configured antenna panels 504 or sub-panels for CSI-RS), or if the base station has exited the power savings mode (e.g., the TRP 502 has reactivated all of its configured antenna panels 504 or sub-panels for CSI-RS), the base station may transmit CSI-RS from its antenna ports in non-power saving resources associated with 32 antenna ports for the UE to measure CSI.

In one example, the base station may dynamically indicate (e.g., via a MAC-CE or DCI) whether the base station is transmitting CSI-RS in power saving resources or non-power saving resources, and the UE may measure CSI in the indicated resources accordingly for CSI reporting. Such approach allows the base station to efficiently configure CSI reporting for dynamic antenna port adaptation through a single CSI report configuration, rather than inefficiently through multiple CSI report configurations to support dynamic antenna port adaptation (or different dynamic antenna port adaptations). In another example, the UE may measure CSI in power saving resources and non-power saving resources for CSI reporting, and the base station may determine from the CSI report which antenna ports (e.g., panels or sub-panels) to deactivate. Such approach allows the UE to become involved in the dynamic antenna port adaptation process (e.g., which antenna ports the base station may deactivate) and thus promotes UE involvement in network energy saving efforts. In a further example, the previous two examples may be combined. For instance, after the base station determines which antenna ports to deactivate from the CSI report as in the aforementioned second example, the base station may provide dynamic indications of resources as in the aforementioned first example. In this way, UE involvement in network energy savings with efficient CSI report configurations may be achieved.

The following description of various aspects of the present disclosure illustrate and refer specifically to NZP CMR resource sets, NZP CMR resources, non-power saving CMR resources, and power saving CMR resources. These illustrations and descriptions are not intended to be limiting and are intended to refer to one example of resources, namely resources for channel measurement. However, it should be understood that the aspects of the present disclosure are not limited to channel measurement resources and may alternatively, or additionally, refer to interference measurement resources. For example, any reference in the drawings and subsequent paragraphs to NZP CMR resource sets, NZP CMR resources, non-power saving CMR resources, and power saving CMR resources may be replaced respectively with CSI-IM resource sets, CSI-IM resources, non-power saving CSI-IM resources, and power saving CSI-IM resources, in one example. Alternatively or additionally, such references may be replaced respectively with NZP IMR resource sets, NZP IMR resources, non-power saving NZP IMR resources, and power saving NZP IMR resources, in another example.

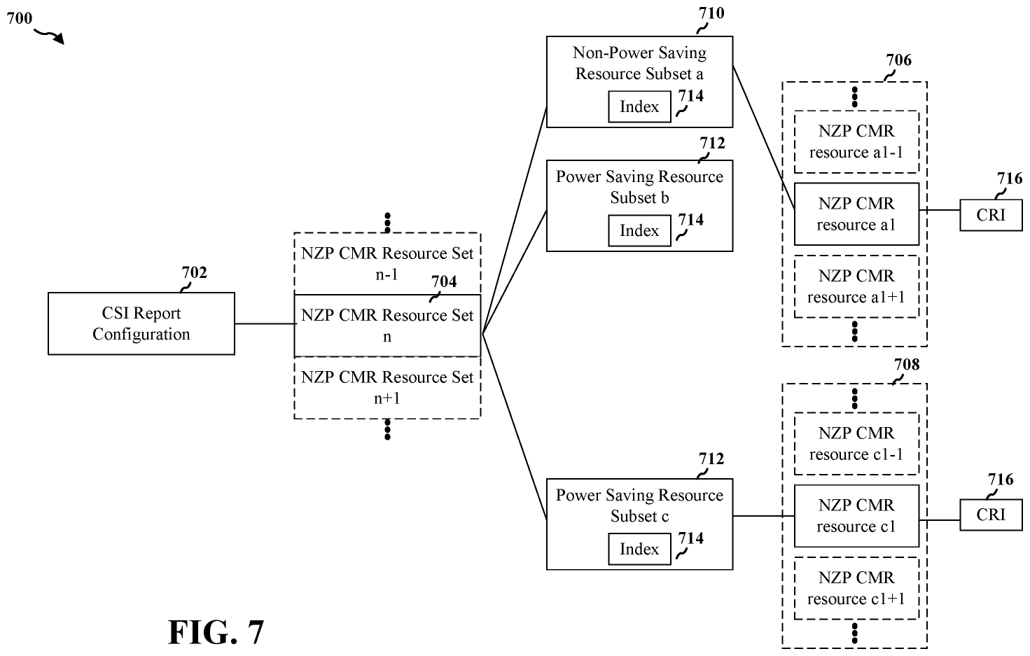

FIG. 7 illustrates an example 700 of a CSI report configuration 702 according to one aspect of the present disclosure. In this aspect, the base station may configure, in CSI report configuration 702, a single NZP CMR resource set 704 (e.g., N resource sets where N=1) containing non-power saving CMR resources 706 and power saving CMR resources 708. For instance, the single NZP CMR resource set may include a resource subset 710 containing non-power saving CMR resources 706 (e.g., resource subset a in FIG. 7), and one or multiple resource subsets 712 containing power saving CMR resources 708 (e.g., resource subsets b and c in FIG. 7). Each of the CMR resources in a same resource subset may be associated with the same number of antenna ports for CSI-RS. For example, referring to FIG. 7, the non-power saving CMR resources 706 in resource subset a may each include one number of antenna ports (e.g., NZP CMR resources a1−1, a1, and a1+1 may all be associated with 32 antenna ports), the power saving CMR resources 708 in resource subset b may each include another number of antenna ports (e.g., 16 antenna ports), and the power saving CMR resources 708 in resource subset c may each include another number of antenna ports (e.g., NZP CMR resources c1−1, c1, and c1+1 may all be associated with 8 antenna ports).

Each resource subset 710, 712 may also be associated with an index 714, and the base station may dynamically indicate the index (or indices) of one or more resource subsets in which the UE may perform CMR measurements. For instance, the base station may provide a MAC-CE or DCI indicating the index 714 of one or more resource subsets 712 containing power saving CMR resources 708, or the index 714 of the resource subset 710 containing non-power saving CMR resources 706, and the UE may measure CSI in the resources 706, 708 of the indicated resource subset(s) in response to the MAC-CE or DCI. The UE may then include in the CSI report (or in multiple CSI reports) a CRI 716 associated with the best resource in the indicated resource subset(s). For instance, in the example of FIG. 7, in response to the dynamic indication of resource subset a, the UE may determine that NZP CMR resource a1 is associated with the highest SINR of resource subset a and thus report the CRI 716 associated with NZP CMR resource a1 to the base station accordingly, or in response to the dynamic indication of resource subset c, the UE may determine that NZP CMR resource c1 is associated with the highest SINR of resource subset c and thus report the CRI 716 associated with NZP CMR resource c1 to the base station accordingly.

In one example, if the base station dynamically indicates one resource subset 712 in MAC-CE or DCI (e.g., resource subset a, b or c), the UE may report one CRI 716 in a CSI report. In another example, if the base station dynamically indicates multiple resource subsets 712 (e.g., resource subsets b and c), the UE may report multiple CRIs 716 in one CSI report or one CRI 716 in multiple CSI reports. In such case where the base station receives multiple CRIs in one or more CSI reports (one for each indicated resource subset), the base station may determine the resource subset corresponding to each received CRI based on the CRI itself and the order of resources in each resource subset. Alternatively, in another aspect of the present disclosure, the UE may include in the CSI report(s) the index 714 of the resource subset 712 associated with each CRI 716. For instance, if the base station configures the UE to measure resources in multiple resource subsets (e.g., resource subsets b and c), the base station may determine the resource subset corresponding to each received CRI (e.g., resource subset b or c) based on the index of the resource subset included in the CSI report.

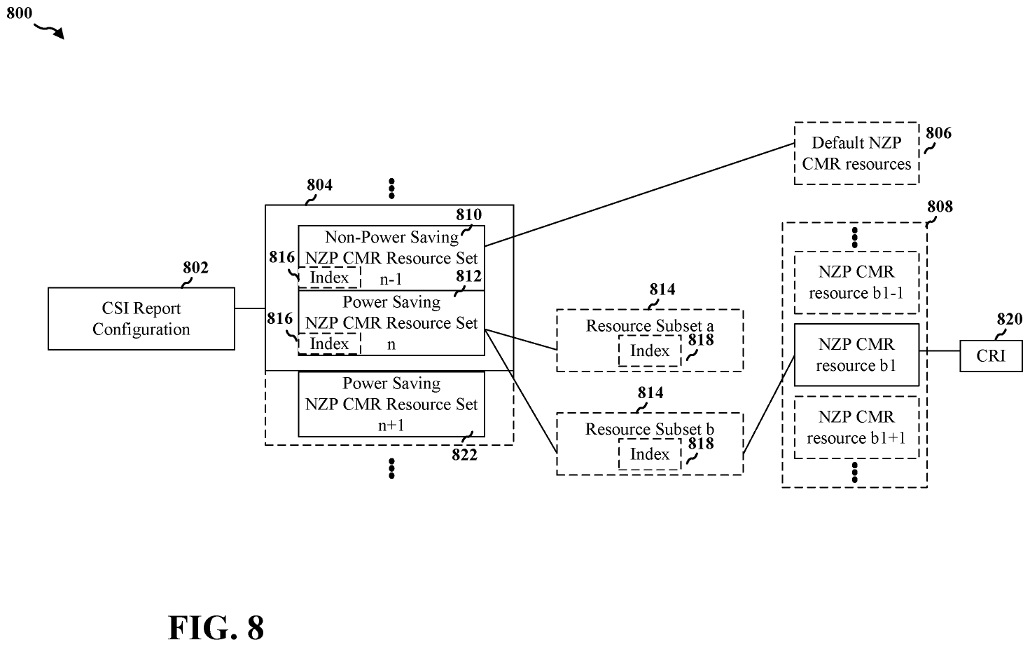

FIG. 8 illustrates an example 800 of a CSI report configuration 802 according to another aspect of the present disclosure. In this aspect, the base station may configure, in CSI report configuration 802, multiple NZP CMR resource sets 804 (e.g., N resource sets where N≥2) respectively containing non-power saving CMR resources 806 and power saving CMR resources 808. For instance, the multiple NZP CMR resource sets 804 may include a non-power savings CMR resource set 810 containing non-power saving CMR resources 806 (e.g., NZP CMR resource set n−1 in FIG. 8) and a power savings CMR resource set 812 containing power saving CMR resources 808 (e.g., NZP CMR resource set n in FIG. 8). Moreover, power savings CMR resource set 812 may include multiple resource subsets 814 of power saving CMR resources 808 (e.g., resource subsets a and b in FIG. 8), and each of the CMR resources in a same resource subset may be associated with the same number of antenna ports for CSI-RS. For example, referring to FIG. 8, the non-power saving CMR resources 806 may each include one number of antenna ports (e.g., 32 antenna ports), the power saving CMR resources 808 in resource subset a may each include another number of antenna ports (e.g., 16 antenna ports), and the power saving CMR resources 808 in resource subset b may each include another number of antenna ports (e.g., NZP CMR resources b1−1, b1, and b1+1 may all be associated with 8 antenna ports).

In one example, each NZP CMR resource set 804 may be associated with an index 816, and the base station may dynamically indicate the index (or indices) of the NZP CMR resource set in which the UE may perform CMR measurements. For instance, the base station may provide a MAC-CE or DCI indicating the index 816 of the non-power saving CMR resource set 810 containing non-power saving CMR resources 806, or the index 816 of the power saving CMR resource set 812 containing power saving CMR resources 808, and the UE may measure CSI in the resources 806, 808 of the indicated resource set in response to indicated index in the MAC-CE or DCI. Until the base station provides the MAC-CE or DCI indicating the index 816 of the resource set for CSI measurement, the UE may measure the non-power saving CMR resources 806 in the non-power saving CMR resource set 810 by default. Moreover, if multiple resource subsets 814 of power saving CMR resource set 812 are configured, each resource subset may also be associated with an index 818, and the base station may further dynamically indicate the index (or indices) of one or more resource subsets in which the UE may perform CMR measurements in the power saving CMR resources 808. For instance, if the base station provides a MAC-CE or DCI indicating the index 816 of power saving CMR resource set 812, the base station may also indicate in the same or different MAC-CE or DCI the index 818 of one or more resource subsets 814 containing power saving CMR resources 808, and the UE may measure CSI in the resources 808 of the indicated resource subset(s) in response to the MAC-CE or DCI. The UE may then include in the CSI report (or in multiple CSI reports) a CRI 820 associated with the best resource in the indicated resource set or subset(s). For instance, in the example of FIG. 8, in response to the dynamic indication(s) of the power savings CMR resource set 812 and resource subset b, the UE may determine that NZP CMR resource b1 is associated with the highest SINR of resource subset b and thus report the CRI 820 associated with NZP CMR resource b1 to the base station accordingly. Moreover, if multiple resource subsets 814 of power saving CMR resource set 812 are configured, the UE may include in the CSI report the index 818 of the resource subset 814 associated with each CRI 820. For instance, if the base station configures the UE to measure resources in multiple resource subsets (e.g., resource subsets a and b), the base station may determine the resource subset corresponding to each received CRI (e.g., resource subset a or b) based on the index of the resource subset included in the CSI report.

In the above example, the base station has deactivated one or more of its antenna panels or sub-panels in the power savings mode, and thus may dynamically indicate the index (or indices) of the NZP CMR resource set in which the UE may perform CMR measurements accordingly. Alternatively, in another example, the base station may not yet have deactivated any of its antenna panels or sub-panels in the power savings mode, and thus may not provide such dynamic indication to the UE. Rather, in this example, the base station may determine which of its antenna panel(s) or sub-panel(s) to deactivate in response to CSI feedback from the UE. For instance, in response to receiving CSI-RS from the base station, the UE may measure CSI in the resources 806, 808 of the non-power saving CMR resource set 810 and the power saving CMR resource set 812 respectively. The UE may then provide a single CSI report including the CRI 820 associated with whichever resource has the best performance (e.g., the highest SINR), and the index 816 of the resource set (non-power saving or power saving) associated with the CRI. Alternatively, the UE may provide multiple CSI reports, one for each resource set (non-power saving and power saving), where each CSI report includes the CRI 820 associated with the resource having the best performance (e.g., highest SINR) and the index 816 of the resource set associated with the CRI. The UE may determine whether to provide the single CSI report or the multiple CSI reports in response to a configuration from the base station (e.g., in the CSI report configuration 802 or in another RRC message). In response to receiving the CSI report(s), the base station may determine whether to deactivate a number of its antenna panels or sub-panels to reduce energy expenditure efficiently. For example, the base station may determine to deactivate one or more of its antenna ports if the reported CSI associated with a power saving CMR resource indicates an acceptable level of channel quality (e.g., high SINR) compared to the CSI associated with a non-power saving CMR resource. In such case, the number of deactivated antenna ports may be based on the reported CSI (e.g., the level of channel quality) associated with the power saving CMR resource. Afterwards, the CSI measurement process may be similar to the previously described example. For instance, after the base station determines to deactivate one or more of its antenna ports, the base station may provide a dynamic indication to the UE indicating the index (or indices) of the NZP CMR resource set (and resource subsets) in which the UE may perform CMR measurements as previously described.

In the previously described examples, a single, power saving CMR resource set 812 (e.g., NZP CMR resource set n in FIG. 8) was configured from multiple NZP CMR resource sets 804 in CSI report configuration 802. Alternatively, the base station may configure multiple (e.g., a number N) power saving CMR resource sets containing power saving CMR resources 808. For instance, the base station may configure power saving CMR resource set 822, in addition to power saving CMR resource set 812 (e.g., NZP CMR resource sets n and n+1 in FIG. 8), for CSI-RS transmission and CSI measurement in the power savings mode. In such case, each of the CMR resources in a same resource set may be associated with the same number of antenna ports for CSI-RS. For example, referring to FIG. 8, the power saving CMR resources 808 in power saving CMR resource set 812 may each include one number of antenna ports (e.g., 16 antenna ports), and the power saving CMR resources 808 in power saving CMR resource set 822 may each include another number of antenna ports (e.g., 4 antenna ports). Otherwise, the same aspects described above for a single, power saving CMR resource set apply for multiple power saving CMR resource sets. For example, power savings CMR resource set 822 may similarly include multiple resource subsets of power saving CMR resources 808, and each of the CMR resources in a same resource subset may be associated with the same number of antenna ports for CSI-RS. Moreover, power savings CMR resource set 822 may be associated with an index (e.g., index 816), and if multiple resource subsets are configured, each resource subset of power savings CMR resource set 822 may similarly be associated with an index. In such case, the base station may dynamically indicate the index/indices in MAC-CE or DCI to trigger the UE to perform CMR measurements in corresponding resources. The UE may then include in the CSI report (or in multiple CSI reports) a CRI associated with the best resource in the indicated resource set or subset(s), the index of the associated resource set, and if applicable, the index of the associated resource subset. Alternatively, rather than providing a dynamic indication to the UE, the base station may determine which antenna panel(s) or sub-panel(s) to deactivate in response to CSI measurements in resources of power savings CMR resource set 822. For instance, in response to receiving CSI-RS, the UE may measure CSI in the resources 808 of power saving CMR resource set 822 as well as the other resource sets, and the UE may provide CSI report(s) including a CRI and index 816 of the resource set accordingly.

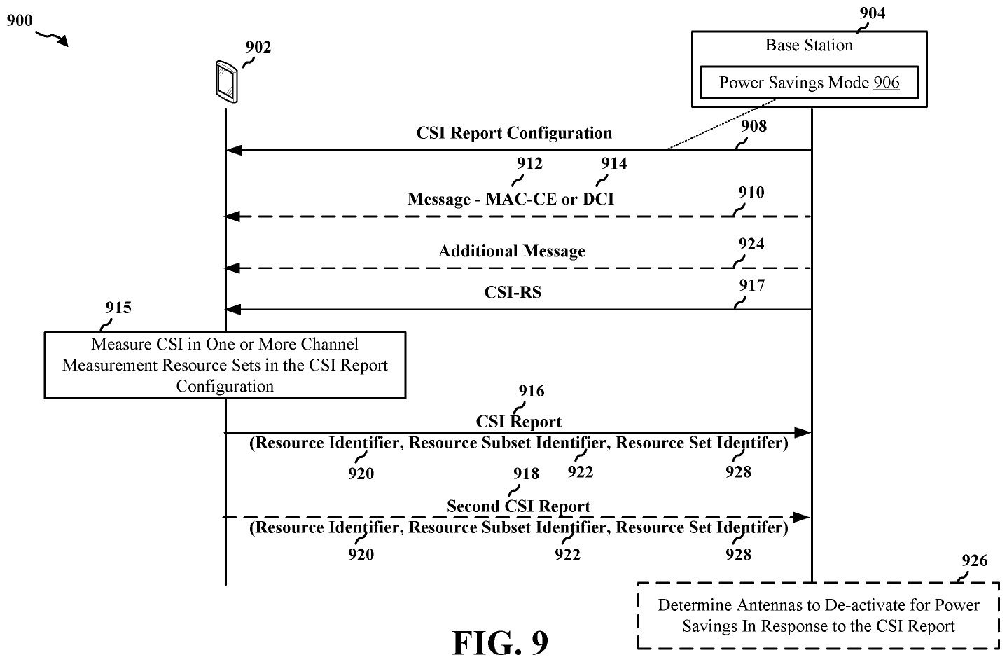

FIG. 9 illustrates an example 900 of a call flow between a UE 902 and a base station 904 operating in a power savings mode 906. While in the power savings mode 906, the base station may deactivate one or more of its antenna panels (e.g., antenna panels 504) or sub-panels to reduce power consumption through dynamic antenna port adaptation, such as described above with respect to FIG. 5. Initially, the base station 904 may transmit a CSI report configuration 908 (e.g., CSI report configuration 702 of FIG. 7 or CSI report configuration 802 of FIG. 8) to the UE 902, followed by a message 910 (e.g., a MAC-CE 912 or DCI 914) triggering the UE at block 915 to measure CSI in one or more channel measurement resource sets in the CSI report configuration 908 (e.g., single NZP CMR resource set 704 in FIG. 7 or multiple NZP CMR resource sets 804 in FIG. 8). The UE may then send a CSI report 916 to the base station including the measured CSI, e.g., periodically, semi-persistently, or aperiodically, in response to transmissions of CSI-RS 917 from the base station according to the CSI report configuration 908 and message 910. For example, at block 915, in response to receiving CSI-RS 917, the UE may identify a SINR associated with each CMR resource in one or more configured resource sets or resource subsets, determine the highest SINR of the identified SINRs and the CRI associated with the resource including the highest SINR, obtain PMI, CQI, and other CSI from the determined CRI, and then report the obtained CSI to the base station in the CSI report 916.

In one example, referring to FIG. 7, the base station 904 may transmit to the UE 902 the CSI report configuration 702, 908 configuring single NZP CMR resource set 704, which includes resource subset 710 containing non-power saving CMR resources 706 and one or more resource subsets 712 containing power saving CMR resources 708. Moreover, each resource subset 710, 712 may be associated with index 714, and the base station 904 may dynamically indicate in the message 910 (e.g., in the MAC-CE 912 or DCI 914) the index (or indices) of one or more of the resource subsets in which the UE may perform CSI measurements at block 915. The UE 902 may then include in the CSI report 916, or in multiple CSI reports including CSI report 916 and a second CSI report 918, a resource identifier 920 (e.g., CRI 716) associated with the best resource (e.g., highest SINR) in the indicated resource subset(s). If the base station dynamically indicates one resource subset 712 in message 910, the UE may report multiple resource identifiers 920 in the CSI report 916. If the base station dynamically indicates multiple resource subsets 712 in message 910, the UE may report multiple resource identifiers 920 in one CSI report (e.g., CSI report 916) or one of the resource identifiers 920 in multiple CSI reports (e.g., CSI report 916, 918). Moreover, the UE may report in the CSI report 916, 918 a resource subset identifier 922 associated with the resource identifier 920 (e.g., the index 714 of the resource subset 712 associated with each CRI 716) for the base station to determine the resource subset corresponding to each received CRI.

In another example, referring to FIG. 8, the base station may transmit CSI report configuration 802, 908 configuring multiple NZP CMR resource sets 804, which includes non-power savings CMR resource set 810 containing non-power saving CMR resources 806 and power savings CMR resource set 812 containing power saving CMR resources 808. Moreover, power savings CMR resource set 812 may include multiple resource subsets 814 of power saving CMR resources 808. Furthermore, each NZP CMR resource set 804 may be associated with index 816, and the base station 904 may dynamically indicate in message 910 (e.g., in the MAC-CE 912 or DCI 914) the index 816 of the non-power saving CMR resource set 810 or power saving CMR resource set 812 in which resources 806 or 808 the UE may perform CSI measurements at block 915. Additionally, if multiple resource subsets 814 of power saving CMR resource set 812 are configured in the CSI report configuration 802, 908, each resource subset may also be associated with index 818, and the base station may further dynamically indicate in message 910 (e.g., in the MAC-CE 912 or DCI 914) or in another message 924 (e.g., in another MAC-CE or DCI) the index (or indices) of one or more resource subsets in which the UE may perform CSI measurements in the power saving CMR resources 808 at block 915. The UE 902 may then include in the CSI report 916, or in multiple CSI reports including CSI report 916 and second CSI report 918, the resource identifier 920 (e.g., CRI 820) associated with the best resource (e.g., highest SINR) in the indicated resource set or subset(s). If multiple resource subsets 814 of power saving CMR resource set 812 are configured, the UE may also include in the CSI report 916 or 918 the resource subset identifier 922 associated with the resource identifier 920 (e.g., the index 818 of the resource subset 814 associated with each CRI 820) for the base station to determine the resource subset corresponding to each received CRI.

In some cases, the base station 904 may not provide message 910 (or 912) indicating the NZP CMR resource set in which UE 902 is to perform CSI measurements at block 915. For example, the base station 904 may not yet have deactivated any of its antenna panels 504 or sub-panels in the power savings mode 906, and thus may not provide a dynamic indication to the UE 902 to measure CSI in either power-saving or non-power saving resources. In such case, at block 926, the base station 904 may determine which of its antenna panel(s) 504 or sub-panel(s) to deactivate in response to CSI feedback (e.g., in CSI report 916 or 918) from the UE 902. For instance, referring to FIG. 8, the UE may measure CSI (at block 915) in the resources 806 and 808 of the non-power saving CMR resource set 810 and power saving CMR resource set 812 respectively. Afterwards, the UE 902 may include in a single CSI report (e.g., CSI report 916) the resource identifier 920 (e.g., CRI 820) associated with whichever resource has the best performance in either the non-power saving CMR resource set 810 or the power saving CMR resource set 812, and a resource set identifier 928 (e.g., the index 816 of the resource set associated with the CRI 820) for the base station to determine the resource set corresponding to the received CRI. Alternatively, the UE 902 may provide multiple CSI reports 916, 918, where the UE includes in CSI report 916 and 918 the resource identifiers 920 (e.g., CRI 820) and resource set identifiers 928 associated with the resources having the best performance in the non-power saving resource set and power saving resource set, respectively. In response to receiving the CSI report(s), the base station 904 may determine at block 926 whether to deactivate a number of its antenna panels or sub-panels to reduce energy expenditure efficiently. For example, the base station may determine to deactivate one or more of its antenna ports if the reported CSI associated with a power saving CMR resource indicates an acceptable level of channel quality (e.g., high SINR) compared to the CSI associated with a non-power saving CMR resource. In such case, the number of deactivated antenna ports may be based on the reported CSI (e.g., the level of channel quality) associated with the power saving CMR resource.

In another example, referring to FIGS. 8 and 9, the base station 904 may transmit CSI report configuration 802, 908 configuring multiple NZP CMR resource sets 804 including multiple power savings CMR resource sets containing power saving CMR resources 808. For instance, the base station may configure power saving CMR resource set 822 in addition to power saving CMR resource set 812 for CSI-RS transmission and CSI measurement in the power savings mode 906. Otherwise, the same aspects described above for a single, power saving CMR resource set apply for multiple power saving CMR resource sets.

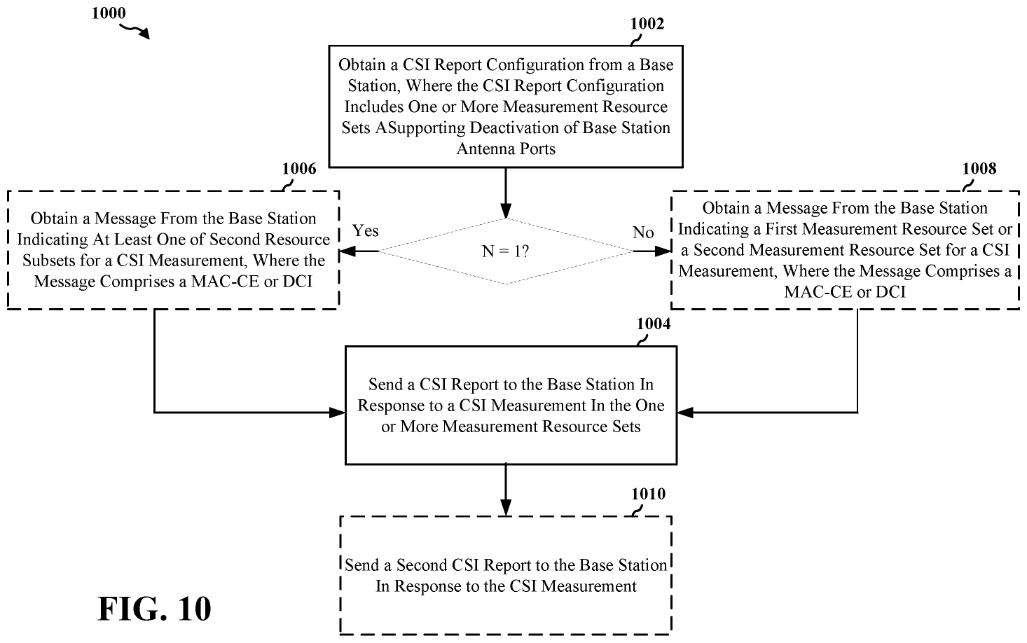

FIG. 10 is a flowchart 1000 of a method of wireless communication. The method may be performed by a UE (e.g., the UE 104, 350, 902; the apparatus 1202). Optional aspects are illustrated in dashed lines. The method allows a UE to provide a CSI report in response to a CSI report configuration accounting for a power savings mode of a base station (e.g., a mode where the base station may perform dynamic antenna port adaptation to reduce energy expenditure).

At 1002, the UE obtains a CSI report configuration from a base station, where the CSI report configuration includes one or more measurement resource sets supporting deactivation of base station antenna ports (e.g., based on a power savings mode of the base station). For example, 1002 may be performed by CSI report configuration component 1240. For instance, referring to FIGS. 7-9, the UE 902 may receive CSI report configuration 702, 802, 908 from base station 904. CSI report configuration 702, 802, 908 may include one or more channel or interference measurement resource sets (e.g., single NZP CMR resource set 704 or multiple NZP CMR resource sets 804) supporting deactivation of base station antenna ports (e.g., based on power savings mode 906 of base station 904). For instance, while in the power savings mode 906, the base station may deactivate antenna ports in one or more of its antenna panels (e.g., antenna panels 504) or sub-panels to reduce power consumption through dynamic antenna port adaptation, such as described above with respect to FIG. 5. In this example, single NZP CMR resource set 704 may contain one or more resource subsets 712 containing power saving CMR resources 708 for CSI-RS transmission and CSI measurement in the power savings mode 906. Similarly, multiple NZP CMR resource sets 804 may include power savings CMR resource set 812 containing power saving CMR resources 808 for CSI-RS transmission and CSI measurement in the power savings mode 906.

In a first aspect, the one or more measurement resource sets may each comprise a first resource subset and a second resource subset, the second resource subset supporting the deactivation of base station antenna ports (e.g., based on a power savings mode of the base station). For example, referring to FIGS. 7 and 9, CSI report configuration 702, 908 may configure single NZP CMR resource set 704 (e.g., N resource sets, where N=1), which includes resource subset 710 (the first resource subset) containing non-power saving CMR resources 706 for CSI-RS transmission and CSI measurement out of the power savings mode 906, and one or more resource subsets 712 (the second resource subset(s)) containing power saving CMR resources 708 for CSI-RS transmission and CSI measurement in the power savings mode 906. In another example, referring to FIGS. 8 and 9, CSI report configuration 802, 908 may configure multiple NZP CMR resource sets 804 (e.g., N resource sets, where N≥2), which each include resource subsets 814 of default NZP CMR resources 806 and power saving CMR resources 808, respectively.

In one example of the first aspect, the first resource subset may include a plurality of first resources each associated with a same first number of antenna ports, and the second resource subset may include a plurality of second resources each associated with a same second number of antenna ports. For instance, referring to FIG. 7, each of the CMR resources in a same resource subset may be associated with the same number of antenna ports for CSI-RS. For example, the power saving CMR resources 708 in one of the resource subsets 712 (e.g., resource subset b) may each include one number of antenna ports (e.g., 16 antenna ports). In another example, the power saving CMR resources 708 in another one of the resource subsets 712 (e.g., resource subset c) may each include another number of antenna ports (e.g., NZP CMR resources c1−1, c1, and c1+1 may all be associated with 8 antenna ports). Similarly, referring to FIG. 8, resource subsets 814 of default NZP CMR resources 806 and power saving CMR resources 808 may each respectively include a same number of antenna ports for each of its resources.

In a second aspect, the one or more measurement resource sets may comprise a first measurement resource set and a second measurement resource set. In one example of the second aspect, the second measurement resource set may support the deactivation of base station antenna ports (e.g., based on a power savings mode of the base station). For example, referring to FIGS. 8 and 9, CSI report configuration 802, 908 may configure multiple NZP CMR resource sets 804 (e.g., N resource sets, where N=2, although N may be greater than 2 in other examples) including non-power savings CMR resource set 810 (the first measurement resource set in this example) containing non-power saving CMR resources 806 for CSI-RS transmission and CSI measurement out of the power savings mode 906, and power savings CMR resource set 812 (the second measurement resource set in this example) containing power saving CMR resources 808 for CSI-RS transmission and CSI measurement in the power savings mode 906. Moreover, the first resource set may include a plurality of first resources each associated with a same first number of antenna ports, and the second resource set may include a plurality of second resources each associated with a same second number of antenna ports. For instance, referring to FIG. 8, each of the CMR resources in a same resource set may be associated with the same number of antenna ports for CSI-RS. For example, non-power saving CMR resources 806 of non-power savings CMR resource set 810 may each include one same number of antenna ports, and power saving CMR resources 808 of power savings CMR resource set 812 may each include another same number of antenna ports.

In one example of the second aspect, the second measurement resource set may include a resource subset, and the resource subset may include a plurality of resources each associated with a same number of antenna ports. For instance, referring to FIG. 8, power savings CMR resource set 812 may include multiple resource subsets 814 of power saving CMR resources 808, and each of the CMR resources in a same resource subset may be associated with the same number of antenna ports for CSI-RS. For example, referring to FIG. 8, the power saving CMR resources 808 in one of the resource subsets 814 (e.g., resource subset a) may each include another number of antenna ports (e.g., 16 antenna ports), and the power saving CMR resources 808 in another one of the resource subsets (e.g., resource subset b) may each include another number of antenna ports (e.g., NZP CMR resources b1−1, b1, and b1+1 may all be associated with 8 antenna ports).

At 1004, the UE sends a CSI report to the base station in response to a CSI measurement in the one or more measurement resource sets. For example, 1004 may be performed by CSI report component 1242. For instance, referring to FIGS. 7-9, in response to measuring CSI at block 915 in resources of the one or more measurement resource sets (e.g., single NZP CMR resource set 704 or multiple NZP CMR resource sets 804 in CSI report configuration 702, 802, 908), the UE 902 may send CSI report 916 to the base station 904. The UE may measure the CSI in response to receiving CSI-RS 917 from the base station according to the CSI report configuration 908. For example, at block 915, in response to receiving CSI-RS 917, the UE may identify a SINR associated with each CMR resource in one or more of the configured resource sets, determine the highest SINR of the identified SINRs and the CRI associated with the resource including the highest SINR, obtain PMI, CQI, and other CSI from the determined CRI, and then report the obtained CSI to the base station in the CSI report 916.

In one example of the first aspect, the one or more measurement resource sets may each comprise a first resource subset and a plurality of second resource subsets, the second resource subsets each supporting the deactivation of base station antenna ports (e.g., based on a power savings mode of the base station). For example, referring to FIG. 7, the single NZP CMR resource set 704 may include resource subset 710 (the first resource subset) containing non-power saving CMR resources 706 and multiple resource subsets 712 (the second resource subsets) containing power saving CMR resources 708. Moreover, at 1006, the UE may obtain a message from the base station indicating at least one of the first resource subsets and the second resource subsets for the CSI measurement, where the message comprises a MAC-CE or DCI. For example, 1006 may be performed by message component 1244. For instance, referring to FIGS. 7 and 9, the UE 902 may obtain message 910 (e.g., MAC-CE 912 or DCI 914) from base station 904 indicating the index 714 (or indices) of one or more of the multiple resource subsets 712 in which the UE may perform CSI measurements at block 915.

In another example of the first aspect, the one or more measurement resource sets may each comprise a first resource subset and a plurality of second resource subsets, the second resource subsets each supporting the deactivation of base station antenna ports (e.g., based on a power savings mode of the base station), and the CSI report may include a resource identifier and a resource subset identifier associated with the CSI measurement in response to the CSI report configuration including the second resource subsets. For example, referring to FIGS. 7 and 9, single NZP CMR resource set 704 may include resource subset 710 (the first resource subset) containing non-power saving CMR resources 706 and multiple resource subsets 712 (the second resource subsets) containing power saving CMR resources 708. Moreover, in response to the single NZP CMR resource set 704 of CSI report configuration 702, 908 including the multiple resource subsets 712 containing power saving CMR resources 708, the UE may report in CSI report 916 the resource identifier 920 (e.g., CRI 716) and resource subset identifier 922 (e.g., index 714 of the resource subset 712 associated with the CRI 716) for the best performing resource (measured at block 915) in the configured resource subsets.

In one example of the second aspect, at 1008, the UE may obtain a message from the base station indicating the first measurement resource set or the second measurement resource set for the CSI measurement, where the message comprises a MAC-CE or DCI. For example, 1008 may be performed by message component 1244. For instance, referring to FIGS. 8 and 9, where the multiple NZP CMR resource sets 804 include non-power savings CMR resource set 810 and power savings CMR resource set 812, the UE may obtain message 910 (e.g., MAC-CE 912 or DCI 914) from base station 904 indicating the index 816 of either the non-power saving CMR resource set 810 or the index 816 of the power saving CMR resource set 812, in which resources 806 or 808 (respectively) the UE may perform CSI measurements at block 915.

In another example of the second aspect, the second measurement resource set may include a plurality of resource subsets, and the message or an additional message from the base station may indicate at least one of the resource subsets for the CSI measurement. For example, referring to FIGS. 8 and 9, multiple resource subsets 814 of power saving CMR resource set 812 may be configured in CSI report configuration 802, 908, where each resource subset may also be associated with index 818. In such case, the base station may further indicate in message 910 or in another message 924 the index 818 (or indices) of one or more of the resource subsets 814 in which the UE may perform CSI measurements at block 914.

In another example of the second aspect, the second measurement resource set may include a plurality of resource subsets, and the CSI report may include a resource identifier and a resource subset identifier associated with the CSI measurement in response to the CSI report configuration including the resource subsets. For example, referring to FIGS. 8 and 9, in response to the power saving CMR resource set 812 including multiple resource subsets 814 containing power saving CMR resources 808, the UE may report in CSI report 916 the resource identifier 920 (e.g., CRI 820) and resource subset identifier 922 (e.g., index 818 of the resource subset 814 associated with the CRI 820) for the best performing resource (measured at block 915) in the configured resource subsets.

In another example of the second aspect, the first measurement resource set may include default resources for the CSI measurement. For example, referring to FIGS. 8 and 9, the UE 902 may measure (at block 915) the non-power saving CMR resources 806 in the non-power saving CMR resource set 810 by default until the base station 904 provides the MAC-CE 912 or DCI 914 indicating the index 816 of power saving CMR resource set 812 for CSI measurement.

In another example of the second aspect, the CSI report may include a resource identifier and a resource set identifier associated with the CSI measurement in one of the first measurement resource set or the second measurement resource set. For example, referring to FIGS. 8 and 9, if the base station 904 does not indicate one of the multiple NZP CMR resource sets 804 in which UE 902 is to perform CSI measurements, the UE may measure CSI in the resources 806, 808 of the non-power saving CMR resource set 810 and power saving CMR resource set 812 respectively (at block 915), and the UE may report in CSI report 916 the resource identifier 920 (e.g., CRI 820) associated with whichever resource 806, 808 has the best performance as well as the resource set identifier 928 (e.g., the index 816 of the resource set associated with the CRI 820) corresponding to the reported CRI.

In another example of the second aspect, at 1010, the UE may send a second CSI report to the base station. For example, 1010 may be performed by CSI report component 1242. The CSI report may include a first resource identifier and a first resource set identifier associated with the CSI measurement in the first measurement resource set, and the second CSI report may include a second resource identifier and a second resource set identifier associated with another CSI measurement in the second measurement resource set. For example, referring to FIGS. 8 and 9, if the base station 904 does not indicate one of the multiple NZP CMR resource sets 804 in which UE 902 is to perform CSI measurements, the UE may measure CSI in the resources 806, 808 of the non-power saving CMR resource set 810 and power saving CMR resource set 812 respectively (at block 915). Then, the UE may report in CSI report 916 the resource identifier 920 (e.g., CRI 820) and resource set identifier 928 (e.g., the index 816 of the resource set associated with the CRI 820) for the best performing resource in the non-power saving CMR resource set 810. Moreover, the UE may report in CSI report 918 the resource identifier 920 (e.g., CRI 820) and resource set identifier 928 (e.g., the index 816 of the resource set associated with the CRI 820) for the best performing resource in the power saving CMR resource set 812. The best performing resources may be determined at block 915 respectively from different CSI measurements in the non-power saving CMR resource set 810 and the power saving CMR resource set 812.

In another example of the second aspect, the one or more measurement resource sets may comprise a first measurement resource set and a plurality of second measurement resource sets, each of the second channel measurement resource sets supporting the deactivation of base station antenna ports (e.g., based on a power savings mode of the base station). For example, referring to FIGS. 8 and 9, the multiple NZP CMR resource sets 804 configured in CSI report configuration 802, 908 may include non-power savings CMR resource set 810 (the first measurement resource set in this example) containing non-power saving CMR resources 806 and multiple power savings CMR resource sets 812, 822 (the second measurement resource sets in this example) containing power saving CMR resources 808 for CSI-RS transmission and CSI measurement in the power savings mode 906.

In another example of the second aspect, each of the second measurement resource sets may include a plurality of resources, and each of the resources in one of the second measurement resource sets may be associated with a same number of antenna ports. For example, referring to FIG. 8, each of the power savings CMR resource sets 812, 822 of the multiple NZP CMR resource sets 804 configured in CSI report configuration 802, 908 may contain power saving CMR resources 808. Moreover, each of the CMR resources in a same resource set may be associated with the same number of antenna ports for CSI-RS. For example, referring to FIG. 8, the power saving CMR resources 808 in power saving CMR resource set 812 may each include one number of antenna ports (e.g., 16 antenna ports), and the power saving CMR resources 808 in power saving CMR resource set 822 may each include another number of antenna ports (e.g., 4 antenna ports).

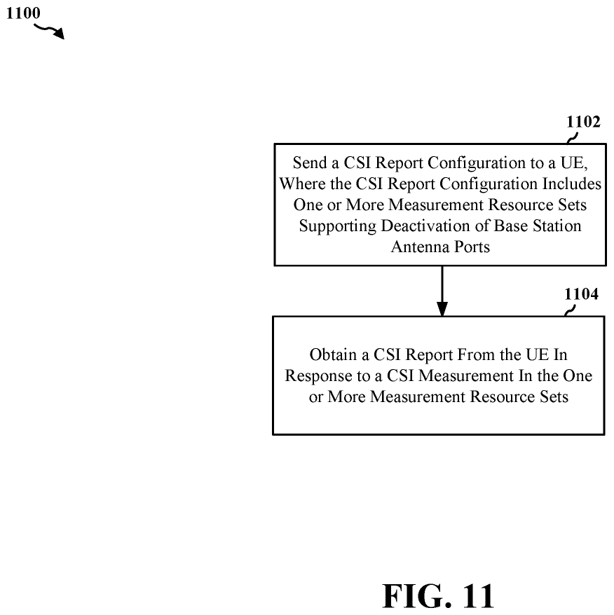

FIG. 11 is a flowchart 1100 of a method of wireless communication. The method may be performed by a base station (e.g., the base station 102/180, 310, 904; the apparatus 1302. The method allows a base station to provide a CSI report configuration to a UE accounting for a power savings mode of the base station (e.g., a mode where the base station may perform dynamic antenna port adaptation to reduce energy expenditure).

At 1102, the base station sends a CSI report configuration to a UE, where the CSI report configuration includes one or more measurement resource sets supporting deactivation of base station antenna ports (e.g., based on a power savings mode of the base station). For example, 1102 may be performed by CSI report configuration component 1340. For instance, referring to FIGS. 7-9, the base station 904 may transmit CSI report configuration 702, 802, 908 to UE 902. CSI report configuration 702, 802, 908 may include one or more channel or interference measurement resource sets (e.g., single NZP CMR resource set 704 or multiple NZP CMR resource sets 804) supporting deactivation of base station antenna ports (e.g., based on power savings mode 906 of base station 904). For instance, while in the power savings mode 906, the base station may deactivate antenna ports in one or more of its antenna panels (e.g., antenna panels 504) or sub-panels to reduce power consumption through dynamic antenna port adaptation, such as described above with respect to FIG. 5. In this example, single NZP CMR resource set 704 may contain one or more resource subsets 712 containing power saving CMR resources 708 for CSI-RS transmission and CSI measurement in the power savings mode 906. Similarly, multiple NZP CMR resource sets 804 may include power savings CMR resource set 812 containing power saving CMR resources 808 for CSI-RS transmission and CSI measurement in the power savings mode 906.

In a first aspect, the one or more measurement resource sets may each comprise a first resource subset and a second resource subset, the second resource subset supporting the deactivation of base station antenna ports (e.g., based on a power savings mode of the base station). For example, referring to FIGS. 7 and 9, CSI report configuration 702, 908 may configure single NZP CMR resource set 704 (e.g., N resource sets, where N=1), which includes resource subset 710 (the first resource subset) containing non-power saving CMR resources 706 for CSI-RS transmission and CSI measurement out of the power savings mode 906, and one or more resource subsets 712 (the second resource subset(s)) containing power saving CMR resources 708 for CSI-RS transmission and CSI measurement in the power savings mode 906. In another example, referring to FIGS. 8 and 9, CSI report configuration 802, 908 may configure multiple NZP CMR resource sets 804 (e.g., N resource sets, where N≥2), which each include resource subsets 814 of default NZP CMR resources 806 and power saving CMR resources 808, respectively.

In one example of the first aspect, the first resource subset may include a plurality of first resources each associated with a same first number of antenna ports, and the second resource subset may include a plurality of second resources each associated with a same second number of antenna ports. For instance, referring to FIG. 7, each of the CMR resources in a same resource subset may be associated with the same number of antenna ports for CSI-RS. For example, the power saving CMR resources 708 in one of the resource subsets 712 (e.g., resource subset b) may each include one number of antenna ports (e.g., 16 antenna ports). In another example, the power saving CMR resources 708 in another one of the resource subsets 712 (e.g., resource subset c) may each include another number of antenna ports (e.g., NZP CMR resources c1−1, c1, and c1+1 may all be associated with 8 antenna ports). Similarly, referring to FIG. 8, resource subsets 814 of default NZP CMR resources 806 and power saving CMR resources 808 may each respectively include a same number of antenna ports for each of its resources.

In a second aspect, the one or more measurement resource sets may comprise a first measurement resource set and a second measurement resource set. In one example of the second aspect, the second measurement resource set may support the deactivation of base station antenna ports (e.g., based on a power savings mode of the base station). For example, referring to FIGS. 8 and 9, CSI report configuration 802, 908 may configure multiple NZP CMR resource sets 804 (e.g., N resource sets, where N=2 in this example, although N may be greater than 2 in other examples) including non-power savings CMR resource set 810 (the first measurement resource set in this example) containing non-power saving CMR resources 806 for CSI-RS transmission and CSI measurement out of the power savings mode 906, and power savings CMR resource set 812 (the second measurement resource set in this example) containing power saving CMR resources 808 for CSI-RS transmission and CSI measurement in the power savings mode 906. Moreover, the first resource set may include a plurality of first resources each associated with a same first number of antenna ports, and the second resource set may include a plurality of second resources each associated with a same second number of antenna ports. For instance, referring to FIG. 8, each of the CMR resources in a same resource set may be associated with the same number of antenna ports for CSI-RS. For example, non-power saving CMR resources 806 of non-power savings CMR resource set 810 may each include one same number of antenna ports, and power saving CMR resources 808 of power savings CMR resource set 812 may each include another same number of antenna ports.

At 1104, the base station obtains a CSI report from the UE in response to a CSI measurement in the one or more measurement resource sets. For example, 1104 may be performed by CSI report component 1342. For instance, referring to FIGS. 7-9, the base station 904 may receive CSI report 916 from the UE 902. The CSI report 916 may be received in response to the UE measuring CSI at block 915 in resources of the one or more measurement resource sets (e.g., single NZP CMR resource set 704 or multiple NZP CMR resource sets 804 in CSI report configuration 702, 802, 908). The CSI measurement at block 915 may in turn be performed in response to a CSI-RS 917 transmitted from the base station to the UE according to the CSI report configuration 908.

In one example of the first aspect, the one or more measurement resource sets may each comprise a first resource subset and a plurality of second resource subsets, the second resource subsets each supporting the deactivation of base station antenna ports (e.g., based on a power savings mode of the base station), and the CSI report may include a resource identifier and a resource subset identifier associated with the CSI measurement in response to the CSI report configuration including the second resource subsets. For example, referring to FIGS. 7 and 9, single NZP CMR resource set 704 may include resource subset 710 (the first resource subset) containing non-power saving CMR resources 706 and multiple resource subsets 712 (the second resource subsets) containing power saving CMR resources 708. Moreover, in response to the single NZP CMR resource set 704 of CSI report configuration 702, 908 including the multiple resource subsets 712 containing power saving CMR resources 708, the base station 904 may obtain in CSI report 916 the resource identifier 920 (e.g., CRI 716) and resource subset identifier 922 (e.g., index 714 of the resource subset 712 associated with the CRI 716) for the best performing resource (measured at block 915) in the configured resource subsets.

In one example of the second aspect, the one or more measurement resource sets may comprise a first measurement resource set and a plurality of second measurement resource sets, and each of the second measurement resource sets supporting the deactivation of base station antenna ports (e.g., based on a power savings mode of the base station). For example, referring to FIGS. 8 and 9, the multiple NZP CMR resource sets 804 configured in CSI report configuration 802, 908 may include non-power savings CMR resource set 810 (the first measurement resource set in this example) containing non-power saving CMR resources 806 and multiple power savings CMR resource sets 812, 822 (the second measurement resource sets in this example) containing power saving CMR resources 808 for CSI-RS transmission and CSI measurement in the power savings mode 906.

In another example of the second aspect, each of the second measurement resource sets may include a plurality of resources, and each of the resources in one of the second measurement resource sets may be associated with a same number of antenna ports. For example, referring to FIG. 8, each of the power savings CMR resource sets 812, 822 of the multiple NZP CMR resource sets 804 configured in CSI report configuration 802, 908 may contain power saving CMR resources 808. Moreover, each of the CMR resources in a same resource set may be associated with the same number of antenna ports for CSI-RS. For example, referring to FIG. 8, the power saving CMR resources 808 in power saving CMR resource set 812 may each include one number of antenna ports (e.g., 16 antenna ports), and the power saving CMR resources 808 in power saving CMR resource set 822 may each include another number of antenna ports (e.g., 4 antenna ports).

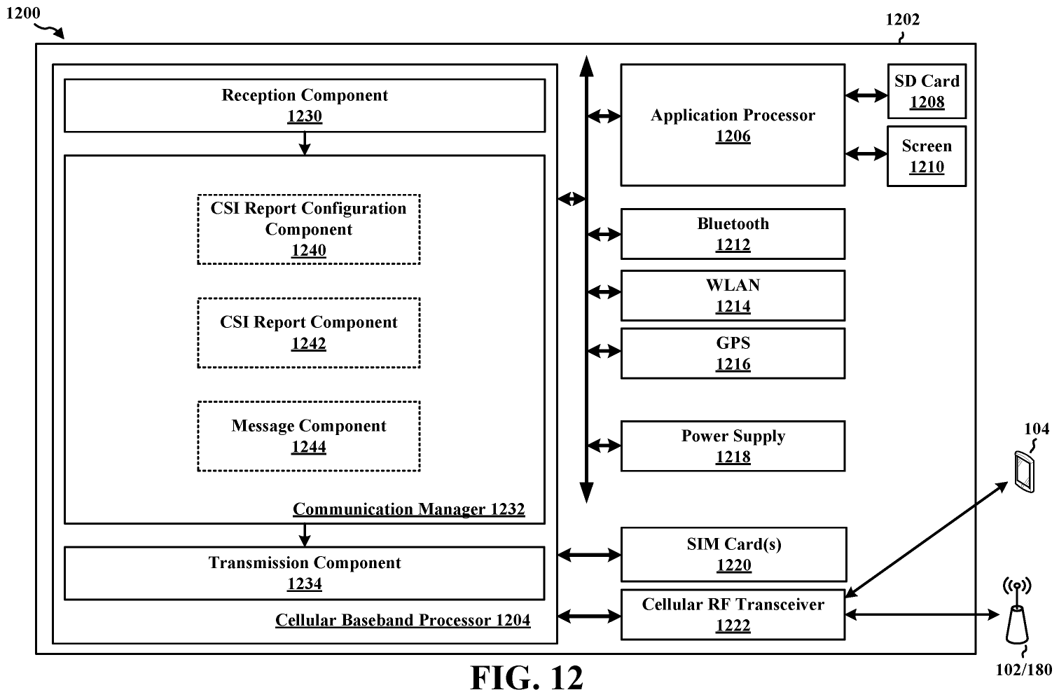

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a CSI report configuration component 1240 that is configured to obtain a CSI report configuration from a base station, where the CSI report configuration includes one or more measurement resource sets supporting deactivation of base station antenna ports, e.g., as described in connection with 1002. The communication manager 1232 further includes a CSI report component 1242 that receives input in the form of the one or more measurement resource sets from the CSI report configuration component 1240 and is configured to send a CSI report to the base station in response to a CSI measurement in the one or more measurement resource sets, e.g., as described in connection with 1004. The communication manager 1232 further includes a message component 1244 that receives input in the form of the one or more measurement resource sets each comprising a first resource subset and a plurality of second resource subsets from the CSI report configuration component 1240 and is configured to obtain a message from the base station indicating at least one of the second resource subsets for the CSI measurement, where the message comprises a MAC-CE or DCI, e.g., as described in connection with 1006. The message component 1244 further receives input in the form of the one or more measurement resource sets comprising a first measurement resource set and a second measurement resource set from the CSI report configuration component 1240 and is further configured to obtain a message from the base station indicating the first measurement resource set or the second measurement resource set for the CSI measurement, where the message comprises a MAC-CE or DCI, e.g., as described in connection with 1008. The CSI report component 1242 further receives input in the form of the one or more measurement resource sets comprising a first measurement resource set and a second measurement resource set from the CSI report configuration component 1240 and is further configured to send a second CSI report to the base station, where the CSI report includes a first resource identifier and a first resource set identifier associated with the CSI measurement in the first measurement resource set, and where the second CSI report includes a second resource identifier and a second resource set identifier associated with another CSI measurement in the second measurement resource set, e.g., as described in connection with 1010.

The apparatus may include additional components that perform each of the blocks of the algorithm in the aforementioned flowcharts of FIGS. 9 and 10. As such, each block in the aforementioned flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for obtaining a channel state information (CSI) report configuration from a base station, wherein the CSI report configuration includes one or more measurement resource sets supporting deactivation of base station antenna ports; and means for sending a CSI report to the base station in response to a CSI measurement in the one or more measurement resource sets.

In one configuration, the one or more measurement resource sets may each comprise a first resource subset and a second resource subset, the second resource subset supporting the deactivation of base station antenna ports, where the first resource subset includes a plurality of first resources each associated with a same first number of antenna ports, and the second resource subset includes a plurality of second resources each associated with a same second number of antenna ports.

In one configuration, the one or more measurement resource sets may each comprise a first resource subset and a plurality of second resource subsets, the second resource subsets each supporting the deactivation of base station antenna ports, and the means for obtaining may be further configured to obtain a message from the base station indicating at least one of the first resource subsets and the second resource subsets for the CSI measurement, wherein the message comprises a medium access control (MAC) control element (MAC-CE) or downlink control information (DCI).

In one configuration, the one or more measurement resource sets may comprise a first measurement resource set and a second measurement resource set, the second measurement resource set supporting the deactivation of base station antenna ports, where the first resource set includes a plurality of first resources each associated with a same first number of antenna ports, and the second resource set includes a plurality of second resources each associated with a same second number of antenna ports.

In one configuration, the means for obtaining may be further configured to obtain a message from the base station indicating the first measurement resource set or the second measurement resource set for the CSI measurement, wherein the message comprises a medium access control (MAC) control element (MAC-CE) or downlink control information (DCI).

In one configuration, the means for sending may be further configured to send a second CSI report to the base station; wherein the CSI report includes a first resource identifier and a first resource set identifier associated with the CSI measurement in the first measurement resource set; and wherein the second CSI report includes a second resource identifier and a second resource set identifier associated with another CSI measurement in the second measurement resource set.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

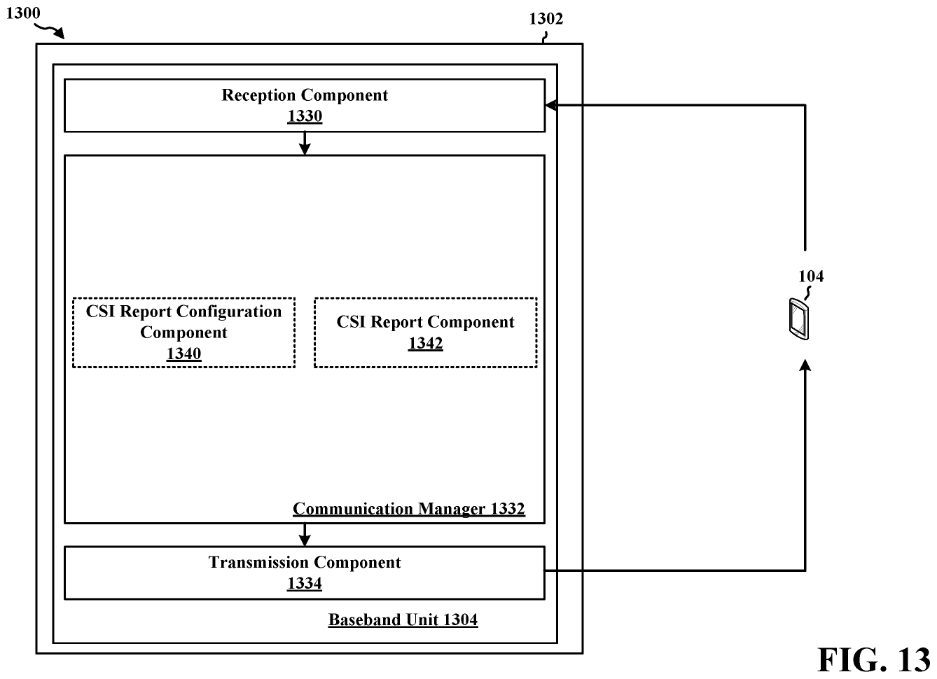

FIG. 13 is a diagram 1300 illustrating an example of a hardware implementation for an apparatus 1302. The apparatus 1302 is a BS and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a CSI report configuration component 1340 that is configured to send a CSI report configuration to a UE, where the CSI report configuration includes one or more measurement resource sets supporting deactivation of base station antenna ports, e.g., as described in connection with 1102. The communication manager 1332 further includes a CSI report component 1342 that receives input in the form of the one or more measurement resource sets from the CSI report configuration component 1340 and is configured to obtain a CSI report from the UE in response to a CSI measurement in the one or more measurement resource sets, e.g., as described in connection with 1104.

The apparatus may include additional components that perform each of the blocks of the algorithm in the aforementioned flowcharts of FIGS. 9 and 11. As such, each block in the aforementioned flowcharts of FIGS. 9 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for sending a channel state information (CSI) report configuration to a user equipment (UE), wherein the CSI report configuration includes one or more measurement resource sets supporting deactivation of base station antenna ports; and means for obtaining a CSI report from the UE in response to a CSI measurement in the one or more measurement resource sets.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Accordingly, aspects of the present disclosure allow a base station to provide CSI report configurations and a UE to provide CSI reports in response to such configurations which account for a power savings mode of the base station. While the base station is operating in the power savings mode, the base station may deactivate one or more of its antenna panels or sub-panels to reduce energy expenditure (e.g., in dynamic antenna port adaptation). Therefore, to account for this antenna port deactivation, the base station may configure one or more resource sets (e.g., NZP CMR, CSI-IM, or NZP IMR) in the CSI report configuration including power saving resources and non-power saving resources. In one example, the base station may dynamically indicate (e.g., via a MAC-CE or DCI) whether the base station is transmitting CSI-RS in power saving resources or non-power saving resources, and the UE may measure CSI in the indicated resources accordingly for CSI reporting. Such approach allows the base station to efficiently configure CSI reporting for dynamic antenna port adaptation through a single CSI report configuration, rather than inefficiently through multiple CSI report configurations to support dynamic antenna port adaptation (or different dynamic antenna port adaptations). In another example, the UE may measure CSI in power saving resources and non-power saving resources for CSI reporting, and the base station may determine from the CSI report which antenna ports (e.g., panels or sub-panels) to deactivate. Such approach allows the UE to become involved in the dynamic antenna port adaptation process (e.g., which antenna ports the base station may deactivate) and thus promotes UE involvement in network energy saving efforts. In a further example, the previous two examples may be combined. For instance, after the base station determines which antenna ports to deactivate from the CSI report as in the aforementioned second example, the base station may provide dynamic indications of resources as in the aforementioned first example. In this way, UE involvement in network energy savings with efficient CSI report configurations may be achieved.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment (UE), comprising: obtaining a channel state information (CSI) report configuration from a base station, wherein the CSI report configuration includes one or more measurement resource sets supporting deactivation of base station antenna ports; and sending a CSI report to the base station in response to a CSI measurement in the one or more measurement resource sets.

Example 2 is the method of Example 1, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

Example 3 is the method of Examples 1 or 2, wherein the one or more measurement resource sets each comprise a first resource subset and a plurality of second resource subsets, the second resource subsets each supporting the deactivation of base station antenna ports, the method further comprising: obtaining a message from the base station indicating at least one of the first resource subsets and the second resource subsets for the CSI measurement, wherein the message comprises a medium access control (MAC) control element (MAC-CE) or downlink control information (DCI).

Example 4 is the method of any of Examples 1 or 2, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

Example 5 is the method of Example 1, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

Example 6 is the method of Example 5, wherein the second measurement resource set includes a resource subset, and the resource subset includes a plurality of resources each associated with a same number of antenna ports.

Example 7 is the method of Example 5 or 6, further comprising: obtaining a message from the base station indicating the first measurement resource set or the second measurement resource set for the CSI measurement, wherein the message comprises a medium access control (MAC) control element (MAC-CE) or downlink control information (DCI).

Example 8 is the method of Example 7, wherein the second measurement resource set includes a plurality of resource subsets, and the message or an additional message from the base station indicates at least one of the resource subsets for the CSI measurement.

Example 9 is the method of any of Examples 5 to 8, wherein the second measurement resource set includes a plurality of resource subsets, and the CSI report includes a resource identifier and a resource subset identifier associated with the CSI measurement in response to the CSI report configuration including the resource subsets.

Example 10 is the method of any of Examples 5 to 9, wherein the first measurement resource set includes default resources for the CSI measurement.

Example 11 is the method of Example 5, wherein the CSI report includes a resource identifier and a resource set identifier associated with the CSI measurement in one of the first measurement resource set or the second measurement resource set.

Example 12 is the method of Example 5, further comprising: sending a second CSI report to the base station; wherein the CSI report includes a first resource identifier and a first resource set identifier associated with the CSI measurement in the first measurement resource set; and wherein the second CSI report includes a second resource identifier and a second resource set identifier associated with another CSI measurement in the second measurement resource set.

Example 13 is the method of any of Examples 1 or 5 to 12, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.

Example 14 is an apparatus for wireless communication, comprising: a processor; memory coupled with the processor; and instructions stored in the memory and operable, when executed by the processor, to cause the apparatus to: obtain a channel state information (CSI) report configuration from a base station, wherein the CSI report configuration includes one or more measurement resource sets supporting deactivation of base station antenna ports; and send a CSI report to the base station in response to a CSI measurement in the one or more measurement resource sets.

Example 15 is the apparatus of Example 14, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

Example 16 is the apparatus of Examples 14 or 15, wherein the one or more measurement resource sets each comprise a first resource subset and a plurality of second resource subsets, the second resource subsets each supporting the deactivation of base station antenna ports, and the instructions, when executed by the processor, further cause the apparatus to: obtain a message from the base station indicating at least one of the first resource subsets and the second resource subsets for the CSI measurement, wherein the message comprises a medium access control (MAC) control element (MAC-CE) or downlink control information (DCI).

Example 17 is the apparatus of Examples 14 or 15, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

Example 18 is the apparatus of Example 14, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

Example 19 is the apparatus of Example 18, wherein the instructions, when executed by the processor, further cause the apparatus to: obtain a message from the base station indicating the first measurement resource set or the second measurement resource set for the CSI measurement, wherein the message comprises a medium access control (MAC) control element (MAC-CE) or downlink control information (DCI).

Example 20 is the apparatus of Example 18, wherein the instructions, when executed by the processor, further cause the apparatus to: send a second CSI report to the base station; wherein the CSI report includes a first resource identifier and a first resource set identifier associated with the CSI measurement in the first measurement resource set; and associated with another CSI measurement in the second measurement resource set.

Example 21 is a method of wireless communication at a base station, comprising: sending a channel state information (CSI) report configuration to a user equipment (UE), wherein the CSI report configuration includes one or more measurement resource sets supporting deactivation of base station antenna ports; and obtaining a CSI report from the UE in response to a CSI measurement in the one or more measurement resource sets.

Example 22 is the method of Example 21, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

Example 23 is the method of Examples 21 or 22, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

Example 24 is the method of Example 21, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

Example 25 is the method of Examples 21 or 24, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.

Example 26 is an apparatus for wireless communication, comprising: a processor; memory coupled with the processor; and instructions stored in the memory and operable, when executed by the processor, to cause the apparatus to: send a channel state information (CSI) report configuration to a user equipment (UE), wherein the CSI report configuration includes one or more measurement resource sets supporting deactivation of base station antenna ports; and obtain a CSI report from the UE in response to a CSI measurement in the one or more measurement resource sets.

Example 27 is the apparatus of Example 26, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

Example 28 is the apparatus of Examples 26 or 27, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

Example 29 is the apparatus of Example 26, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

Example 30 is the apparatus of Examples 26 or 29, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.

What is claimed is:

1. A method of wireless communication at a user equipment (UE), comprising:
obtaining a channel state information (CSI) report configuration from a base station, wherein the CSI report configuration includes one or more measurement resource sets supporting deactivation of base station antenna ports; and
sending a CSI report to the base station in response to a CSI measurement in the one or more measurement resource sets.

2. The method of claim 1, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

3. The method of claim 1, wherein the one or more measurement resource sets each comprise a first resource subset and a plurality of second resource subsets, the second resource subsets each supporting the deactivation of base station antenna ports, the method further comprising:
obtaining a message from the base station indicating at least one of the first resource subsets and the second resource subsets for the CSI measurement, wherein the message comprises a medium access control (MAC) control element (MAC-CE) or downlink control information (DCI).

4. The method of claim 1, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

5. The method of claim 1, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

6. The method of claim 5, wherein the second measurement resource set includes a resource subset, and the resource subset includes a plurality of resources each associated with a same number of antenna ports.

7. The method of claim 5, further comprising:
obtaining a message from the base station indicating the first measurement resource set or the second measurement resource set for the CSI measurement, wherein the message comprises a medium access control (MAC) control element (MAC-CE) or downlink control information (DCI).

8. The method of claim 7, wherein the second measurement resource set includes a plurality of resource subsets, and the message or an additional message from the base station indicates at least one of the resource subsets for the CSI measurement.

9. The method of claim 5, wherein the second measurement resource set includes a plurality of resource subsets, and the CSI report includes a resource identifier and a resource subset identifier associated with the CSI measurement in response to the CSI report configuration including the resource subsets.

10. The method of claim 5, wherein the first measurement resource set includes default resources for the CSI measurement.

11. The method of claim 5, wherein the CSI report includes a resource identifier and a resource set identifier associated with the CSI measurement in one of the first measurement resource set or the second measurement resource set.

12. The method of claim 5, further comprising:
sending a second CSI report to the base station;
wherein the CSI report includes a first resource identifier and a first resource set identifier associated with the CSI measurement in the first measurement resource set; and
wherein the second CSI report includes a second resource identifier and a second resource set identifier associated with another CSI measurement in the second measurement resource set.

13. The method of claim 1, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.

14. An apparatus for wireless communication, comprising:
a processor;
memory coupled with the processor; and
instructions stored in the memory and operable, when executed by the processor, to cause the apparatus to:
obtain a channel state information (CSI) report configuration from a base station, wherein the CSI report configuration includes one or more measurement resource sets supporting deactivation of base station antenna ports; and
send a CSI report to the base station in response to a CSI measurement in the one or more measurement resource sets.

15. The apparatus of claim 14, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

16. The apparatus of claim 14, wherein the one or more measurement resource sets each comprise a first resource subset and a plurality of second resource subsets, the second resource subsets each supporting the deactivation of base station antenna ports, and wherein the instructions, when executed by the processor, further cause the apparatus to:
obtain a message from the base station indicating at least one of the first resource subsets and the second resource subsets for the CSI measurement, wherein the message comprises a medium access control (MAC) control element (MAC-CE) or downlink control information (DCI).

17. The apparatus of claim 14, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

18. The apparatus of claim 14, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

19. The apparatus of claim 18, wherein the instructions, when executed by the processor, further cause the apparatus to:
obtain a message from the base station indicating the first measurement resource set or the second measurement resource set for the CSI measurement, wherein the message comprises a medium access control (MAC) control element (MAC-CE) or downlink control information (DCI).

20. The apparatus of claim 18, wherein the instructions, when executed by the processor, further cause the apparatus to:
send a second CSI report to the base station;
wherein the CSI report includes a first resource identifier and a first resource set identifier associated with the CSI measurement in the first measurement resource set; and
wherein the second CSI report includes a second resource identifier and a second resource set identifier associated with another CSI measurement in the second measurement resource set.

21. A method of wireless communication at a base station, comprising:
sending a channel state information (CSI) report configuration to a user equipment (UE), wherein the CSI report configuration includes one or more measurement resource sets supporting deactivation of base station antenna ports; and
obtaining a CSI report from the UE in response to a CSI measurement in the one or more measurement resource sets.

22. The method of claim 21, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

23. The method of claim 21, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

24. The method of claim 21, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

25. The method of claim 21, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.

26. An apparatus for wireless communication, comprising:
a processor;
memory coupled with the processor; and
instructions stored in the memory and operable, when executed by the processor, to cause the apparatus to:
send a channel state information (CSI) report configuration to a user equipment (UE), wherein the CSI report configuration includes one or more measurement resource sets supporting deactivation of base station antenna ports; and
obtain a CSI report from the UE in response to a CSI measurement in the one or more measurement resource sets.

27. The apparatus of claim 26, wherein the one or more measurement resource sets each comprise a first resource subset and a second resource subset, the second resource subset supporting the deactivation of base station antenna ports, wherein the first resource subset includes a plurality of first resources each associated with a same first number of antenna ports, and the second resource subset includes a plurality of second resources each associated with a same second number of antenna ports.

28. The apparatus of claim 26, wherein the one or more measurement resource sets each comprise a first resource subset and a plurality of second resource subsets, the second resource subsets each supporting the deactivation of base station antenna ports, and the CSI report includes a resource identifier and a resource subset identifier associated with the CSI measurement in response to the CSI report configuration including the second resource subsets.

29. The apparatus of claim 26, wherein the one or more measurement resource sets comprise a first measurement resource set and a second measurement resource set, the second measurement resource set supporting the deactivation of base station antenna ports, wherein the first resource set includes a plurality of first resources each associated with a same first number of antenna ports, and the second resource set includes a plurality of second resources each associated with a same second number of antenna ports.

30. The apparatus of claim 26, wherein the one or more measurement resource sets comprise a first measurement resource set and a plurality of second measurement resource sets, each of the second measurement resource sets supporting the deactivation of base station antenna ports, wherein each of the second measurement resource sets includes a plurality of resources, and each of the resources in one of the second measurement resource sets is associated with a same number of antenna ports.
